(19) United States
(12) Patent Application Publication
(10) Pub. No.: US 2014/0146088 A1
(43) Pub. Date: May 29, 2014

(54) PATTERNED ILLUMINATION SCANNING DISPLAY

(71) Applicant: QUALCOMM MEMS TECHNOLOGIES, INC., San Diego, CA (US)

(72) Inventors: John Michael Wyrwas, Berkeley, CA (US); James Chester Meador, Berkeley, CA (US); Thomas Gordon Brown, Rochester, NY (US); Xiquan Cui, San Jose, CA (US); Ron Lee Feldman, Campbell, CA (US); Russell Wayne Gruhlke, Milpitas, CA (US); Ying Zhou, San Jose, CA (US); Khurshid Syed Alam, Mountain View, CA (US); Kollengode Subramanian Narayanan, Cupertino, CA (US)

(73) Assignee: QUALCOMM MEMS TECHNOLOGIES, INC., San Diego, CA (US)

(21) Appl. No.: 13/685,260

(22) Filed: Nov. 26, 2012

(51) Int. Cl. G09F 13/18; G09G 5/10

(52) U.S. Cl. CPC G09F 13/18; G09G 5/10
USPC 345/690; 250/227.2

(57) ABSTRACT

This disclosure provides systems, methods and apparatus, including computer programs encoded on computer storage media, for providing a compact, low-sensor count scanning display that is capable of both displaying graphical content and of capturing images of objects placed on or above the scanning display. Various implementations are discussed, including raster scan, line scan, and compressive sampling version.

### TECHNICAL FIELD

This disclosure relates to non-projection display devices that are also capable of capturing scanned image data of objects placed in front of the display devices. This disclosure further relates to techniques and devices that may be used with interferometric modulator (IMOD) electromechanical systems.

### DESCRIPTION OF THE RELATED TECHNOLOGY

Electromechanical systems include devices having electrical and mechanical elements, actuators, transducers, sensors, optical components (such as mirrors) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a metallic membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

### SUMMARY

The systems, methods and devices of the disclosure each have several innovative aspects, no single one of which is solely responsible for the desirable attributes disclosed herein.

One innovative aspect of the subject matter described in this disclosure can be implemented in various ways.

In some implementations, an apparatus is provided that includes a non-projection display screen, a collection light guide, and one or more light detectors positioned about the periphery of the collection light guide. The collection light guide may be overlaid on the non-projection display screen and may have a first surface facing the non-projection display screen and a second surface facing away from the non-projection display screen. The second surface may be substantially parallel to, and coextensive with, the first surface. The collection light guide may be configured to redirect light entering the collection light guide via the second surface towards the periphery of the collection light guide.

In some implementations of the apparatus, the collection light guide may be a planar light guide containing light-turning structures, the light-turning structures configured to redirect the light entering the collection light guide via the second surface towards the periphery of the collection light guide. In some further implementations, each of the one or more light detectors positioned about the periphery of the collection light guide may be positioned so as to detect light emitted from a face of the collection light guide, the face having an edge generally defining a portion of the second surface.

In some implementations of the apparatus, the collection light guide may be substantially coextensive with the non-projection display screen.

In some implementations of the apparatus, the periphery of the collection light guide may include four sides substantially forming a rectangle, each of the sides having at least one of the one or more light detectors positioned so as to detect light emitted from the collection light guide via the side. The collection light guide may also include four quadrants, and light entering the collection light guide via the second surface may be substantially redirected towards a side correlated to the quadrant of the collection light guide where the light entered the collection light guide.

In some implementations of the apparatus, each of the one or more light detectors may have a primary axis of light detection, and each of the one or more light detectors may be oriented such that the primary axis of light detection is substantially normal to the first surface.

In some implementations of the apparatus, each of the one or more light detectors may have a primary axis of light detection and may be oriented such that the primary axis of light detection is substantially parallel to the first surface.

In some implementations of the apparatus, the apparatus may further include a front light guide with a third surface and a fourth surface substantially parallel to and coextensive with the third surface, as well as one or more light sources positioned along the periphery of the front light guide. In such implementations, the front light guide may be interposed between the collection light guide and the non-projection display screen, the third surface may face the non-projection display screen, the fourth surface may face the collection light guide, and the front light guide may be configured to redirect light from the one or more light sources entering the front light guide via the periphery of the front light guide towards the non-projection display screen.

In some implementations of the apparatus, the non-projection display screen may be a reflective display screen. In some other implementations, the non-projection display screen may be a transmissive, backlit display screen.

In some implementations of the apparatus, the collection light guide may be configured to permit substantially more light to pass through from the first surface to the second surface than from the second surface to the first surface.

In some implementations of the apparatus, the apparatus may further include a control system. The control system may include at least one processor configured to process image data and at least one memory device communicatively connected with the at least one processor. The at least one memory device may store instructions executable by the at least one processor. The instructions may include instructions to control the at least one processor to cause the non-projection display screen to display a plurality of image patterns, each image pattern including bright pixels and dark pixels; collect light intensity data from the one or more light detectors while each image pattern is displayed; correlate the collected light intensity data with each image pattern; and construct an image of an object, wherein the object is positioned proximate to the second surface while the image patterns are displayed.

In some further implementations of the apparatus, the apparatus may also include a driver circuit configured to send at least one signal to the display screen. In some further implementations of the apparatus, the apparatus may also include a controller configured to send at least a portion of the image data to the driver circuit. In yet some further implementations of the apparatus, the apparatus may also include an image source module configured to send the image data to the at least one processor. In some implementations of the apparatus, the image source module may include at least one of a receiver, transceiver, and transmitter.

In some implementations of the apparatus, the apparatus may further include an input device configured to receive input data and to communicate the input data to the processor.

In some implementations of the apparatus, each image pattern may be a pseudorandom image pattern of bright pixels and dark pixels, and the image of the object may be constructed using compressing sampling techniques.

In some implementations of the apparatus, the second surface may be subdivided into a plurality of parallel light-receiving zones in a first direction. Each light-receiving zone may correspond to at least one of the one or more light detectors, and light passing into the collection light guide from each light-receiving zone may be redirected and channeled along a mean path substantially perpendicular to the first direction and parallel to the second surface. The light from each light-receiving zone may be kept substantially isolated from the light from the other light-receiving zones during redirection and channeling, and the at least one light detector corresponding to each light-receiving zone may be positioned so as to detect the light channeled from each light-detecting zone.

In some further implementations of the apparatus, each image pattern may have dark pixels and an array of bright pixels extending across the non-projection display screen in a direction parallel to the first direction. In some further implementations of the apparatus, each image pattern may be monochromatic and the instructions may also include instructions to control the at least one processor to correlate the collected light intensity data for each image pattern with the color of the image pattern.

In some implementations, a machine-readable, non-transitory storage medium is provided. The machine-readable, non-transitory storage medium may have computer-executable instructions stored thereon for controlling one or more processors to cause a non-projection display screen to display a plurality of image patterns, each image pattern including bright pixels and dark pixels and to collect light intensity data from one or more light detectors while each image pattern is displayed. The one or more light detectors may be positioned about the periphery of a collection light guide overlaid on the non-projection display screen, and the collection light guide may be configured to take light entering the collection light guide and travelling towards the non-projection display screen and redirect the light towards the periphery of the collection light guide. The machine-readable, non-transitory storage medium may have further computer-executable instructions stored thereon for controlling one or more processors to correlate the collected light intensity data with each image pattern and to construct an image of an object, wherein the object is positioned proximate to the second surface while the image patterns are displayed.

In some implementations of the machine-readable, non-transitory storage medium, each image pattern may be monochromatic and the computer-executable instructions may further include instructions to control the one or more processors to correlate the collected light intensity data for each image pattern with the color of the image pattern.

In some implementations of the machine-readable, non-transitory storage medium, each image pattern may be monochromatic and the machine-readable, non-transitory storage medium may have further computer-executable instructions stored thereon for further controlling the one or more processors to determine the light intensity data correlated with each image pattern by summing together individual light intensity data from each of the light detectors in the one or more light detectors.

In some implementations of the machine-readable, non-transitory storage medium, the machine-readable, non-transitory storage medium may have further computer-executable instructions stored thereon for further controlling the one or more processors to display each image pattern multiple times. The image patterns may be monochromatic and each display of a given image pattern in the plurality of image patterns may be in a different color.

In some implementations of the machine-readable, non-transitory storage medium, the machine-readable, non-transitory storage medium may have further computer-executable instructions stored thereon for further controlling the one or more processors to construct the image of the object using compressive sampling techniques, and each of the image patterns may be a pseudorandom pattern of bright pixels and dark pixels.

In some implementations, an apparatus is provided that includes a non-projection display means, the non-projection display means configured to display digital images, and a means for redirecting light traveling towards the non-projection display means, the means for redirecting light overlaid on, and substantially coextensive with, the non-projection display means. The means for redirecting light may be configured to redirect the light towards the periphery of the means for redirecting light and may also be planar. The light detection means may be positioned about the periphery of the means for redirecting light and configured to detect light redirected towards the periphery of the means for redirecting light.

In some implementations of the apparatus, the apparatus may further include a controller means. The controller means may be configured to cause the non-projection display means to display a plurality of image patterns, each image pattern including bright pixels and dark pixels, to collect light intensity data from the light detection means while each image pattern is displayed, to correlate the collected light intensity data with each image pattern, and to construct an image of an object positioned proximate to the means for redirecting light while the image patterns are displayed.

In some such implementations of the apparatus, the controller means may construct the image of the object using compressive sampling techniques, and each of the image patterns may be a pseudorandom pattern of bright pixels and dark pixels.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 interferometric modulator display.

FIG. 3 shows an example of a diagram illustrating movable reflective layer position versus applied voltage for the interferometric modulator of FIG. 1.

FIG. 4 shows an example of a table illustrating various states of an interferometric modulator when various common and segment voltages are applied.

FIG. 5A shows an example of a diagram illustrating a frame of display data in the 3×3 interferometric modulator display of FIG. 2.

FIG. 5B shows an example of a timing diagram for common and segment signals that may be used to write the frame of display data illustrated in FIG. 5A.

FIG. 6A shows an example of a partial cross-section of the interferometric modulator display of FIG. 1.

FIGS. 6B-6E show examples of cross-sections of varying implementations of interferometric modulators.

FIG. 7 shows an example of a flow diagram illustrating a manufacturing process for an interferometric modulator.

FIGS. 8A-8E show examples of cross-sectional schematic illustrations of various stages in a method of making an interferometric modulator.

FIG. 9A shows an example of a wedge display.

FIG. 9B shows an example of a folded wedge display.

FIG. 10 shows a side view of a high-level example of a scanning display that may be used with various imaging techniques outlined herein.

FIG. 11 shows a side view of a high-level example of a scanning display with a backlit liquid crystal display (LCD) that may be used with various imaging techniques outlined herein.

FIG. 12 shows a side view of a high-level example of a scanning display with a front-lit reflective display that may be used with various imaging techniques outlined herein.

FIG. 13A shows a side view of an example of one arrangement of a non-projection display screen, a collection light guide, and edge-located light detectors for a scanning display.

FIG. 13B shows a side view of an example of one arrangement of a non-projection display screen, a collection light guide, and light detectors located underneath the collection light guide for a scanning display.

FIG. 14 shows a plan view of an example of light detectors and a planar collection light guide with omni-directional light-turning features for an example scanning display.

FIG. 15A shows an isometric view of an example scanning display with edge-located light detectors and a planar collection light guide with omni-directional light-turning features.

FIG. 15B shows an isometric exploded view of the example scanning display of FIG. 15A.

FIG. 16A shows an isometric view of an example scanning display with a planar collection light guide featuring omni-directional light-turning features and light detectors located underneath the collection light guide.

FIG. 16B shows an isometric exploded view of the example scanning display of FIG. 16A.

FIG. 17 shows a block diagram of an example technique for using a scanning display as described herein to perform raster pixel scanning image acquisition.

FIG. 18 shows a block diagram of an example technique for using a scanning display as described herein to perform compressive sampling image acquisition.

FIG. 19 shows a plan view of an example planar collection light guide with directional light-turning structures.

FIG. 20A shows an isometric view of an example scanning display with a planar collection light guide with directional light-turning structures.

FIG. 20B shows an isometric exploded view of the example scanning display of FIG. 20A.

FIG. 21A shows an isometric view of an example scanning display with a collimated, planar collection light guide.

FIG. 21B shows an isometric exploded view of the example scanning display of FIG. 21A.

FIG. 22 shows a block diagram of an example technique for using a scanning display as described herein to perform raster line scanning image acquisition.

FIG. 23 shows a block diagram of an example scanning display and control system for the scanning display.

FIGS. 24A and 24B depict a flow diagram for a compressive sampling image construction technique using illumination pre-scaling.

FIG. 25 depicts a flow diagram for a compressive sampling image construction technique using illumination post-scaling.

FIGS. 26A and 26B show examples of system block diagrams illustrating a display device that includes a plurality of interferometric modulators.

Like reference numbers and designations in the various drawings indicate like elements.

### DETAILED DESCRIPTION

The following detailed description is directed to certain implementations for the purposes of describing the innovative aspects. However, the teachings herein can be applied in a multitude of different ways. The described implementations may be implemented in any device that is configured to display an image, whether in motion (for example, video) or stationary (for example, still image), and whether textual, graphical or pictorial. More particularly, it is contemplated that the implementations may be implemented in or associated with a variety of electronic devices such as, but not limited to, mobile telephones, multimedia Internet enabled cellular telephones, mobile television receivers, wireless devices, smartphones, bluetooth devices, personal data assistants (PDAs), wireless electronic mail receivers, hand-held or portable computers, netbooks, notebooks, smartbooks, printers, copiers, scanners, facsimile devices, GPS receivers/navigators, cameras, MP3 players, camcorders, game consoles, wrist watches, clocks, calculators, television monitors, flat panel displays, electronic reading devices (for example, e-readers), computer monitors, auto displays (for example, odometer display, etc.), cockpit controls and/or displays, camera view displays (for example, display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, packaging (for example, MEMS and non-MEMS), aesthetic structures (for example, display of images on a piece of jewelry) and a variety of electromechanical systems devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes, electronic test equipment. Thus, the teachings are not intended to be limited to the implementations depicted solely in the Figures, but instead have wide applicability as will be readily apparent to one having ordinary skill in the art.

A non-projection display screen may be coupled to a collection light guide that allows light emitted or reflected from the non-projection display screen to pass through the light guide without substantial loss. A non-projection display screen, as used herein, refers to a video display screens such as liquid crystal displays (LCDs), plasma display screens, e-ink displays, interfermetric modulator displays, and other display technologies that do not require optical lensing systems to produce coherent optical output. Non-projection display screens typically produce a source image that is the same scale as the image that is viewed by a user. By contrast, projection display screens, such as rear- or front-projection displays, may include one or more optical elements such as lenses or mirrors that magnify and project a source image that is considerably smaller than the image that is viewed by a user. Projection display screens are typically bulky in comparison to non-projection display screens due to the need to accommodate the focal distances and fields of view of the optical elements used.

The collection light guide may also be configured such that light entering the collection light guide and travelling towards the non-projection display screen is redirected towards the periphery of the collection light guide. One or more light detectors positioned about the periphery of the collection light guide may be used to detect such redirected light. Such implementations allow for image capture of objects placed on, or in close proximity to, the non-projection display screen/collection light guide. In some implementations, light may be emitted from the non-projection display screen, or reflected off of the non-projection display screen, towards such an object. In turn, the object may then reflect some of the light back towards the collection light guide and non-projection display screen. Such light may then be redirected towards the periphery of the collection light guide.

In some implementations, a series of structured image patterns may be displayed on the non-projection display screen in association with an image capture operation; each pattern may have a different arrangement of light and dark pixels, and may cause different amounts of light to be reflected off of the object that is the subject of the image capture operation and into the collection light guide. Accordingly, the light detector(s) positions about the periphery of the collection light guide may measure light intensity values that are then each associated with the corresponding structured image pattern that produced the measured light intensity. The measured light intensity, in conjunction with the structured image patterns, may, using compressive sampling techniques, be used to construct an image of the object.

Particular implementations of the subject matter described in this disclosure may be implemented to realize one or more of the following potential advantages. For example, a non-projection display screen may be provided that is capable of both displaying video image data as a standard video display would, and of capturing digital image data of objects placed on or in close proximity to the non-projection display screen. Moreover, since many of the features that enable such are separate from the pixel elements of the non-projection display screen, implementations of such a non-projection display screen may not require modification of pixel features across the face of the non-projection display screen. Various other advantages may be apparent from the discussions below.

One example of a suitable MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectivity of the interferometric modulator. The reflectivity spectrums of IMODs can create fairly broad spectral bands which can be shifted across the visible wavelengths to generate different colors. The position of the spectral band can be adjusted by changing the thickness of the optical resonant cavity, for example, by changing the position of the reflector.

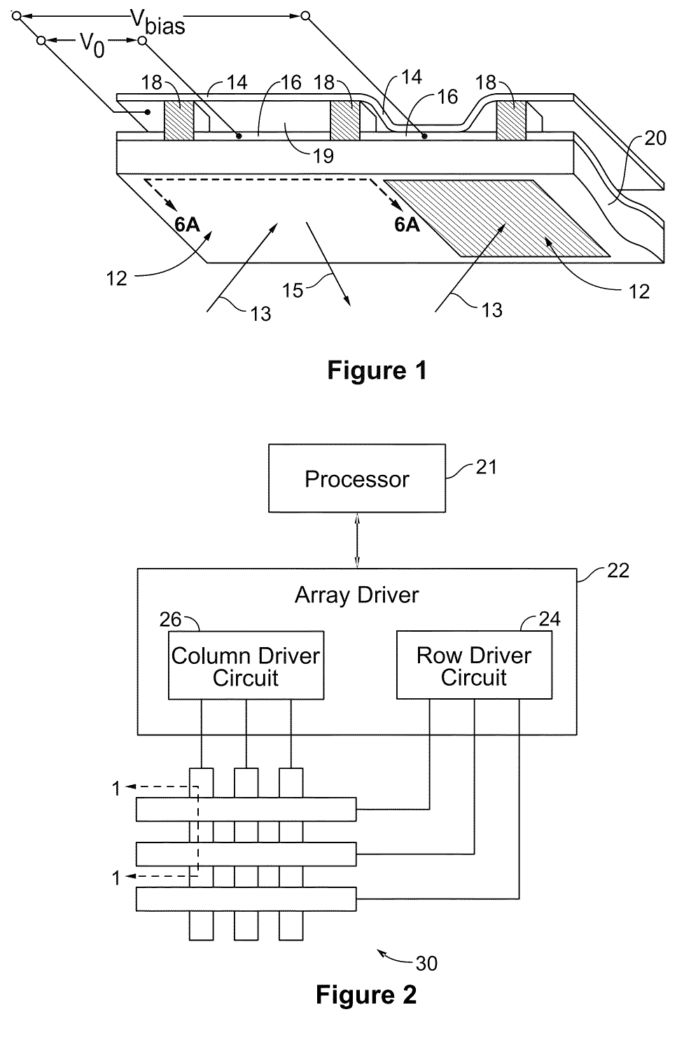

FIG. 1 shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, for example, to a user. Conversely, in the dark (“actuated,” “closed” or “off”) state, the display element reflects little incident visible light. In some implementations, the light reflectivity properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, for example, a movable reflective layer and a fixed partially reflective layer, positioned at a variable and controllable distance from each other to form an air gap (also referred to as an optical gap or cavity). The movable reflective layer may be moved between at least two positions. In a first position, for example, a relaxed position, the movable reflective layer can be positioned at a relatively large distance from the fixed partially reflective layer. In a second position, for example, an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when unactuated, reflecting light outside of the visible range (for example, infrared light). In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 1 includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage V₀ applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage V_{bias} applied across the IMOD 12 on the right is sufficient to maintain the movable reflective layer 14 in the actuated position.

In FIG. 1, the reflective properties of pixels 12 are generally illustrated with arrows 13 indicating light incident upon the pixels 12, and light 15 reflecting from the IMOD 12 on the left. Although not illustrated in detail, it will be understood by one having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the IMOD 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, for example, chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and conductor, while different, more conductive layers or portions (for example, of the optical stack 16 or of other structures of the IMOD) can serve to bus signals between IMOD pixels. The optical stack 16 also can include one or more insulating or dielectric layers covering one or more conductive layers or a conductive/absorptive layer.

In some implementations, the layer(s) of the optical stack 16 can be patterned into parallel strips, and may form row electrodes in a display device as described further below. As will be understood by one having skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be on the order of 1-1000 um, while the gap 19 may be on the order of <10,000 Angstroms (Å).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the IMOD 12 on the left in FIG. 1, with the gap 19 between the movable reflective layer 14 and optical stack 16. However, when a potential difference, for example, voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated IMOD 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 shows an example of a system block diagram illustrating an electronic device incorporating a 3×3 interferometric modulator display. The electronic device includes a processor 21 that may be configured to execute one or more software modules. In addition to executing an operating system, the processor 21 may be configured to execute one or more software applications, including a web browser, a telephone application, an email program, or other software application.

The processor 21 can be configured to communicate with an array driver 22. The array driver 22 can include a row driver circuit 24 and a column driver circuit 26 that provide signals to, for example, a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

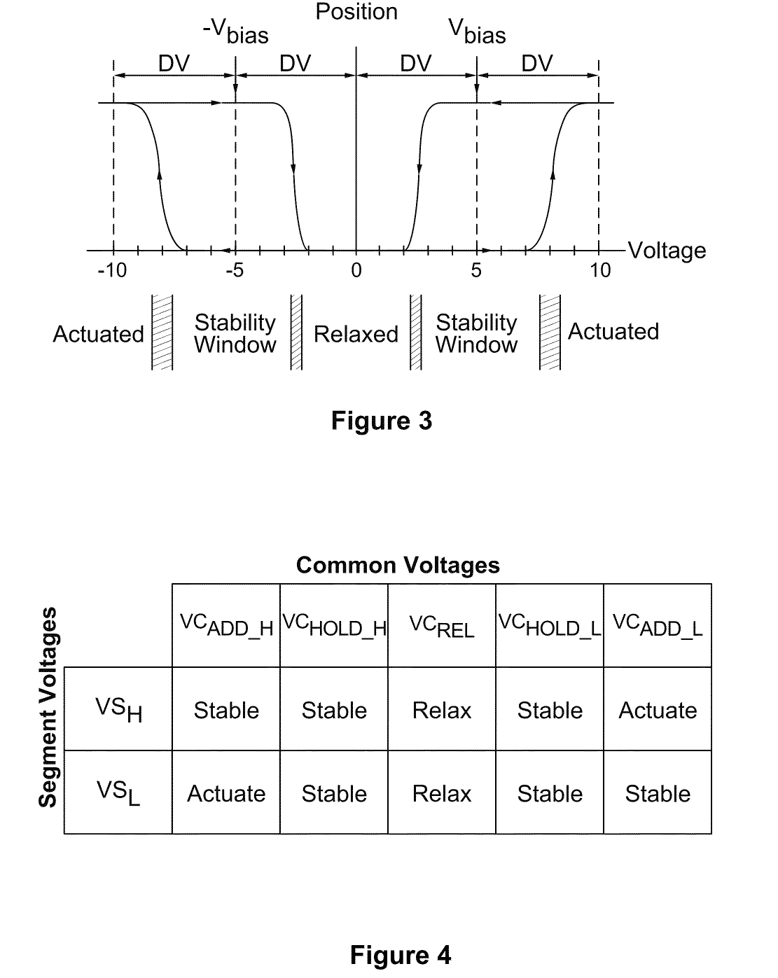

FIG. 3 shows an example of a diagram illustrating movable reflective layer position versus applied voltage for the interferometric modulator of FIG. 1. For MEMS interferometric modulators, the row/column (for example, common/segment) write procedure may take advantage of a hysteresis property of these devices as illustrated in FIG. 3. An interferometric modulator may require, for example, about a 10-volt potential difference to cause the movable reflective layer, or mirror, to change from the relaxed state to the actuated state. When the voltage is reduced from that value, the movable reflective layer maintains its state as the voltage drops back below, for example, 10 volts, however, the movable reflective layer does not relax completely until the voltage drops below 2 volts. Thus, a range of voltage, approximately 3 to 7 volts, as shown in FIG. 3, exists where there is a window of applied voltage within which the device is stable in either the relaxed or actuated state. This is referred to herein as the “hysteresis window” or “stability window.” For a display array 30 having the hysteresis characteristics of FIG. 3, the row/column write procedure can be designed to address one or more rows at a time, such that during the addressing of a given row, pixels in the addressed row that are to be actuated are exposed to a voltage difference of about 10 volts, and pixels that are to be relaxed are exposed to a voltage difference of near zero volts. After addressing, the pixels are exposed to a steady state or bias voltage difference of approximately 5-volts such that they remain in the previous strobing state. In this example, after being addressed, each pixel sees a potential difference within the “stability window” of about 3-7 volts. This hysteresis property feature enables the pixel design, for example, illustrated in FIG. 1, to remain stable in either an actuated or relaxed pre-existing state under the same applied voltage conditions. Since each IMOD pixel, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each pixel (that is, the potential difference across each pixel) determines the resulting state of each pixel. FIG. 4 shows an example of a table illustrating various states of an interferometric modulator when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

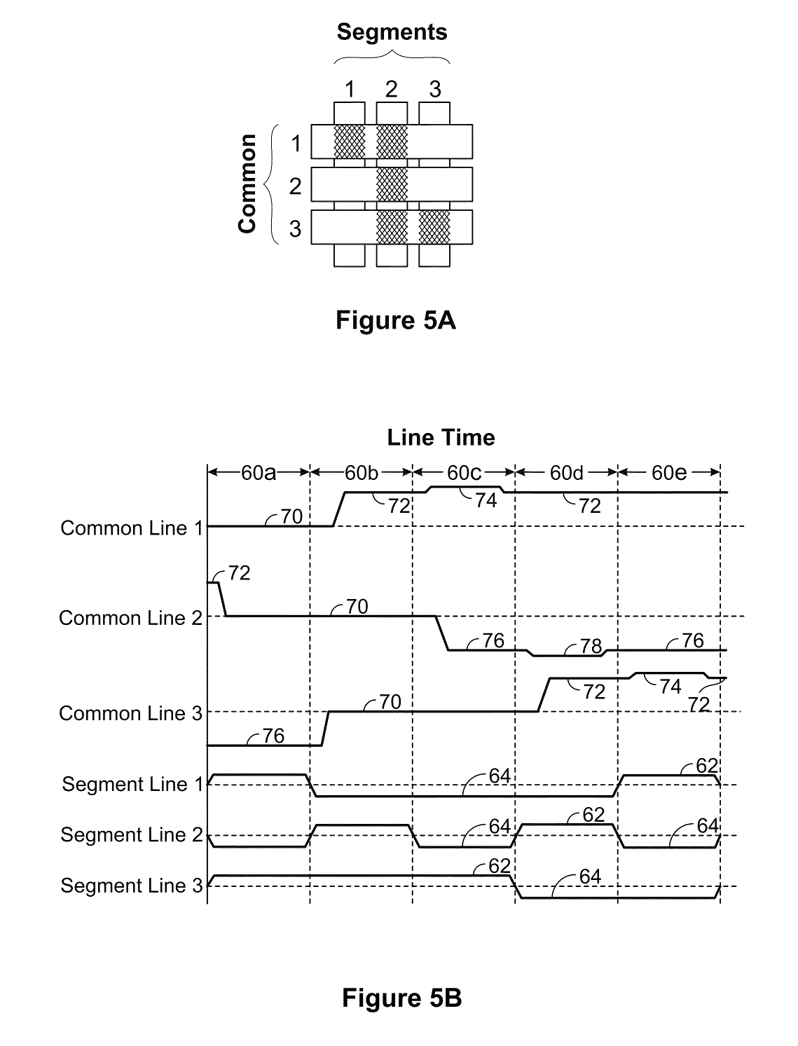

As illustrated in FIG. 4 (as well as in the timing diagram shown in FIG. 5B), when a release voltage VC_{REL} is applied along a common line, all interferometric modulator elements along the common line will be placed in a relaxed state, alternatively referred to as a released or unactuated state, regardless of the voltage applied along the segment lines, for example, high segment voltage VS_{H} and low segment voltage VS_{L}. In particular, when the release voltage VC_{REL} is applied along a common line, the potential voltage across the modulator (alternatively referred to as a pixel voltage) is within the relaxation window (see FIG. 3, also referred to as a release window) both when the high segment voltage VS_{H} and the low segment voltage VS_{L} are applied along the corresponding segment line for that pixel.

When a hold voltage is applied on a common line, such as a high hold voltage VC_{HOLD}_{_{—}}_{H} or a low hold voltage VC_{HOLD}_{_{—}}_{L}, the state of the interferometric modulator will remain constant. For example, a relaxed IMOD will remain in a relaxed position, and an actuated IMOD will remain in an actuated position. The hold voltages can be selected such that the pixel voltage will remain within a stability window both when the high segment voltage VS_{H} and the low segment voltage VS_{L} are applied along the corresponding segment line. Thus, the segment voltage swing, in other words, the difference between the high VS_{H} and low segment voltage VS_{L}, is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that line by application of segment voltages along the respective segment lines. The segment voltages may be selected such that actuation is dependent upon the segment voltage applied. When an addressing voltage is applied along a common line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having no effect (in other words, remaining stable) on the state of the modulator.

In some implementations, hold voltages, address voltages, and segment voltages may be used which always produce the same polarity potential difference across the modulators. In some other implementations, signals can be used which alternate the polarity of the potential difference of the modulators. Alternation of the polarity across the modulators (that is, alternation of the polarity of write procedures) may reduce or inhibit charge accumulation which could occur after repeated write operations of a single polarity.

FIG. 5A shows an example of a diagram illustrating a frame of display data in the 3×3 interferometric modulator display of FIG. 2. FIG. 5B shows an example of a timing diagram for common and segment signals that may be used to write the frame of display data illustrated in FIG. 5A. The signals can be applied to the, for example, 3×3 array of FIG. 2, which will ultimately result in the line time 60e display arrangement illustrated in FIG. 5A. The actuated modulators in FIG. 5A are in a dark-state, in other words, where a substantial portion of the reflected light is outside of the visible spectrum so as to result in a dark appearance to, for example, a viewer. Prior to writing the frame illustrated in FIG. 5A, the pixels can be in any state, but the write procedure illustrated in the timing diagram of FIG. 5B presumes that each modulator has been released and resides in an unactuated state before the first line time 60a.

During the first line time 60a, a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. With reference to FIG. 4, the segment voltages applied along segment lines 1, 2 and 3 will have no effect on the state of the interferometric modulators, as none of common lines 1, 2 or 3 are being exposed to voltage levels causing actuation during line time 60a (in other words, VC_{REL}—relax and VC_{HOLD}_{_{—}}_{L}—stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the high end of the positive stability window (in other words, the voltage differential exceeded a predefined threshold) of the modulators, and the modulators (1,1) and (1,2) are actuated. Conversely, because a high segment voltage 62 is applied along segment line 3, the pixel voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 pixel array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (for example, line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the necessary line time. Specifically, in implementations in which the release time of a modulator is greater than the actuation time, the release voltage may be applied for longer than a single line time, as depicted in FIG. 5B. In some other implementations, voltages applied along common lines or segment lines may vary to account for variations in the actuation and release voltages of different modulators, such as modulators of different colors.

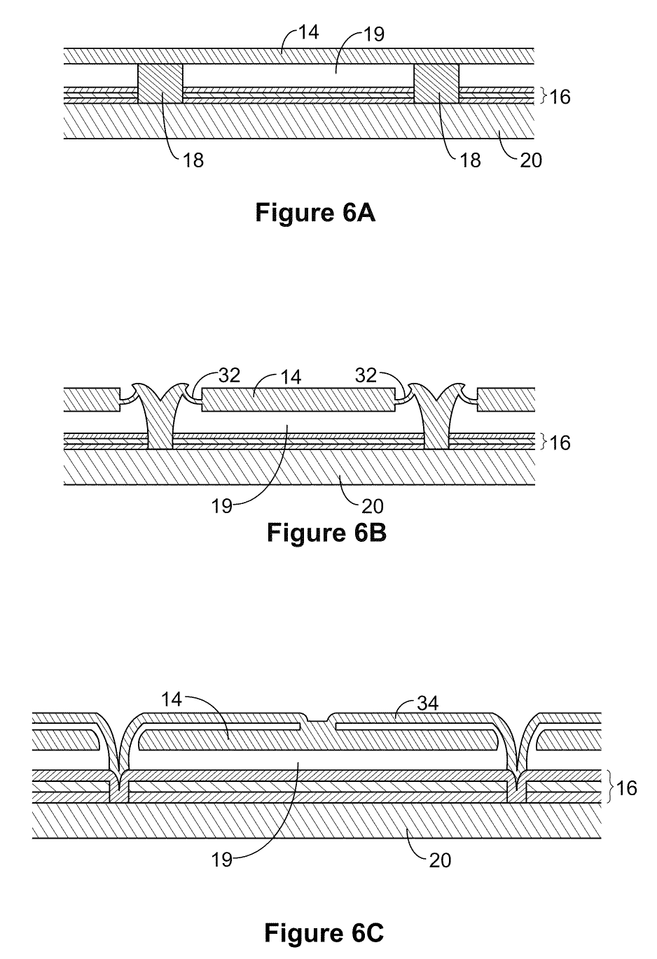

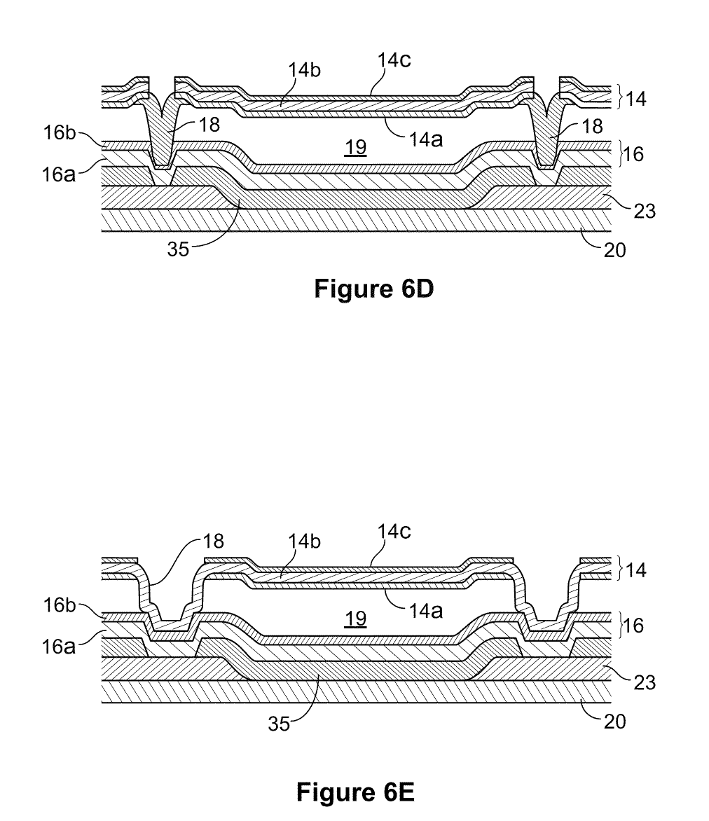

The details of the structure of interferometric modulators that operate in accordance with the principles set forth above may vary widely. For example, FIGS. 6A-6E show examples of cross-sections of varying implementations of interferometric modulators, including the movable reflective layer 14 and its supporting structures.

FIG. 6A shows an example of a partial cross-section of the interferometric modulator display of FIG. 1, where a strip of metal material, for example, the movable reflective layer 14, is deposited on supports 18 extending orthogonally from the substrate 20. In FIG. 6B, the movable reflective layer 14 of each IMOD is generally square or rectangular in shape and attached to supports at or near the corners, on tethers 32. In FIG. 6C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 6C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 6D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (for example, part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, an SiO₂/SiON/SiO₂ tri-layer stack. Either or both of the reflective sub-layer 14a and the conductive layer 14c can include, for example, an Al alloy with about 0.5% Cu, or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 6D, some implementations also can include a black mask structure 23. The black mask structure 23 can be formed in optically inactive regions (for example, between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, an SiO₂ layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, CF₄ and/or O₂ for the MoCr and SiO₂ layers and Cl₂ and/or BCl₃ for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 6E shows another example of an IMOD, where the movable reflective layer 14 is self-supporting. In contrast with FIG. 6D, the implementation of FIG. 6E does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 6E when the voltage across the interferometric modulator is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer.

In implementations such as those shown in FIGS. 6A-6E, the IMODs function as direct-view devices, in which images are viewed from the front side of the transparent substrate 20, for example, the side opposite to that upon which the modulator is arranged. In these implementations, the back portions of the device (that is, any portion of the display device behind the movable reflective layer 14, including, for example, the deformable layer 34 illustrated in FIG. 6C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 6A-6E can simplify processing, such as, for example, patterning.

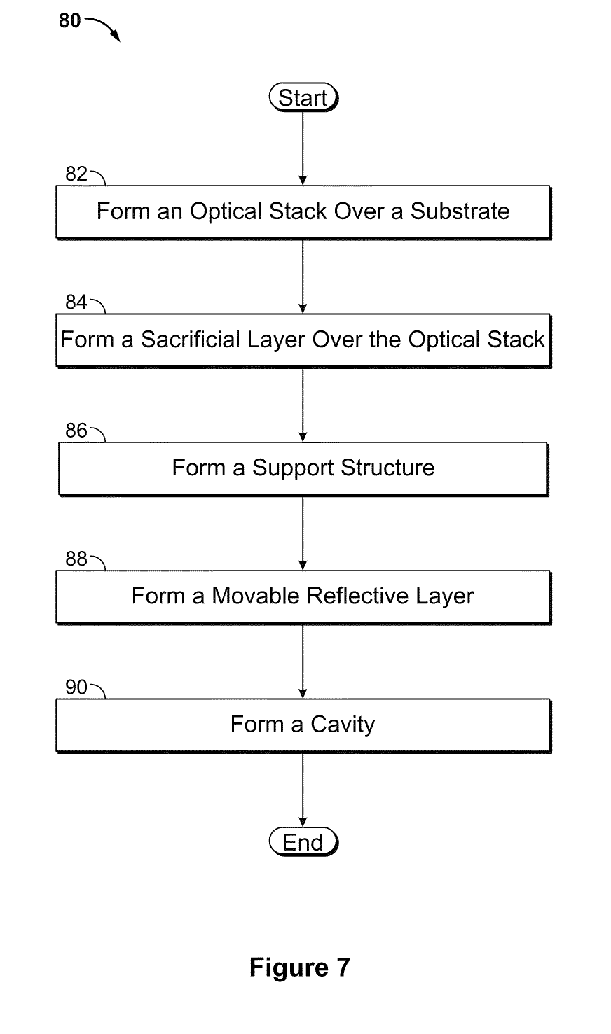

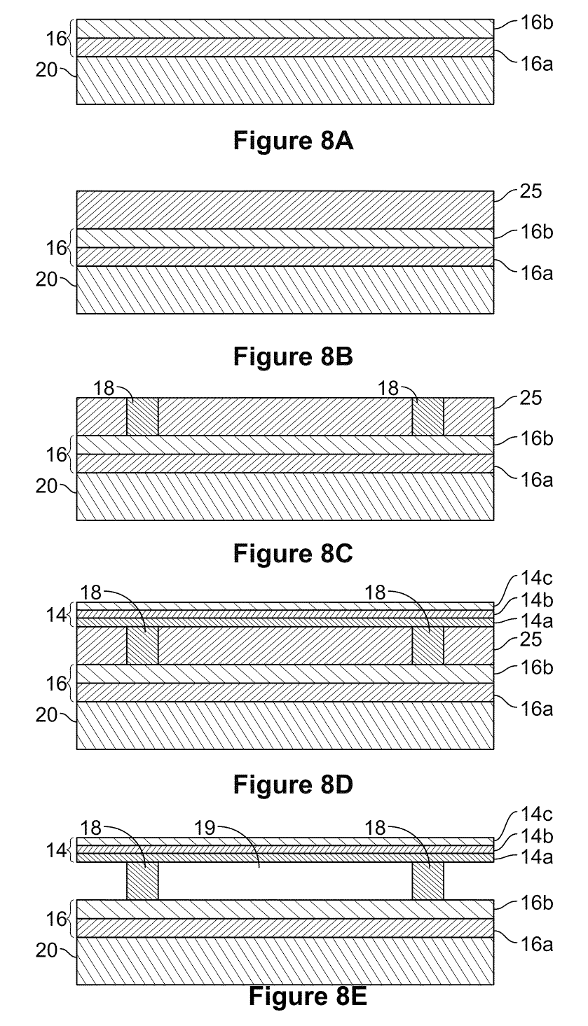

FIG. 7 shows an example of a flow diagram illustrating a manufacturing process 80 for an interferometric modulator, and FIGS. 8A-8E show examples of cross-sectional schematic illustrations of corresponding stages of such a manufacturing process 80. In some implementations, the manufacturing process 80 can be implemented to manufacture, for example, interferometric modulators of the general type illustrated in FIGS. 1 and 6, in addition to other blocks not shown in FIG. 7. With reference to FIGS. 1, 6 and 7, the process 80 begins at block 82 with the formation of the optical stack 16 over the substrate 20. FIG. 8A illustrates such an optical stack 16 formed over the substrate 20. The substrate 20 may be a transparent substrate such as glass or plastic, it may be flexible or relatively stiff and unbending, and may have been subjected to prior preparation processes, for example, cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In FIG. 8A, the optical stack 16 includes a multilayer structure having sub-layers 16a and 16b, although more or fewer sub-layers may be included in some other implementations. In some implementations, one of the sub-layers 16a, 16b can be configured with both optically absorptive and conductive properties, such as the combined conductor/absorber sub-layer 16a. Additionally, one or more of the sub-layers 16a, 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (for example, one or more reflective and/or conductive layers). In addition, the optical stack 16 can be patterned into individual and parallel strips that form the rows of the display.

The process 80 continues at block 84 with the formation of a sacrificial layer 25 over the optical stack 16. The sacrificial layer 25 is later removed (for example, at block 90) to form the cavity 19 and thus the sacrificial layer 25 is not shown in the resulting interferometric modulators 12 illustrated in FIG. 1. FIG. 8B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (Si), in a thickness selected to provide, after subsequent removal, a gap or cavity 19 (see also FIGS. 1 and 8E) having a desired design size. Deposition of the sacrificial material may be carried out using deposition techniques such as physical vapor deposition (PVD, for example, sputtering), plasma-enhanced chemical vapor deposition (PECVD), thermal chemical vapor deposition (thermal CVD), or spin-coating.

The process 80 continues at block 86 with the formation of a support structure for example, a post 18 as illustrated in FIGS. 1, 6 and 8C. The formation of the post 18 may include patterning the sacrificial layer 25 to form a support structure aperture, then depositing a material (e.g., a polymer or an inorganic material, for example, silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 6A. Alternatively, as depicted in FIG. 8C, the aperture formed in the sacrificial layer 25 can extend through the sacrificial layer 25, but not through the optical stack 16. For example, FIG. 8E illustrates the lower ends of the support posts 18 in contact with an upper surface of the optical stack 16. The post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 8C, but also can, at least partially, extend over a portion of the sacrificial layer 25. As noted above, the patterning of the sacrificial layer 25 and/or the support posts 18 can be performed by a patterning and etching process, but also may be performed by alternative etching methods.

The process 80 continues at block 88 with the formation of a movable reflective layer or membrane such as the movable reflective layer 14 illustrated in FIGS. 1, 6 and 8D. The movable reflective layer 14 may be formed by employing one or more deposition processes, for example, reflective layer (e.g., aluminum, aluminum alloy) deposition, along with one or more patterning, masking, and/or etching processes. The movable reflective layer 14 can be electrically conductive, and referred to as an electrically conductive layer. In some implementations, the movable reflective layer 14 may include a plurality of sub-layers 14a, 14b, 14c as shown in FIG. 8D. In some implementations, one or more of the sub-layers, such as sub-layers 14a, 14c, may include highly reflective sub-layers selected for their optical properties, and another sub-layer 14b may include a mechanical sub-layer selected for its mechanical properties. Since the sacrificial layer 25 is still present in the partially fabricated interferometric modulator formed at block 88, the movable reflective layer 14 is typically not movable at this stage. A partially fabricated IMOD that contains a sacrificial layer 25 may also be referred to herein as an “unreleased” IMOD. As described above in connection with FIG. 1, the movable reflective layer 14 can be patterned into individual and parallel strips that form the columns of the display.

The process 80 continues at block 90 with the formation of a cavity, for example, cavity 19 as illustrated in FIGS. 1, 6 and 8E. The cavity 19 may be formed by exposing the sacrificial material 25 (deposited at block 84) to an etchant. For example, an etchable sacrificial material such as Mo or amorphous Si may be removed by dry chemical etching, for example, by exposing the sacrificial layer 25 to a gaseous or vaporous etchant, such as vapors derived from solid XeF₂ for a period of time that is effective to remove the desired amount of material, typically selectively removed relative to the structures surrounding the cavity 19. Other combinations of etchable sacrificial material and etching methods, for example wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

The IMODs as described herein may be components of reflective displays, for example, ambient light reflects off of the “bright” IMODs to form an image. In ambient environments with little or no illumination, for example, nighttime, a front light may be used to provide a source of light that is directed towards the IMODs and reflected off of the bright IMODs. In contrast, traditional transmissive LCDs may rely on a backlight that emits light that passes through the LCD pixels.

Reflective, including IMOD, and transmissive, including LCD, displays can thus both be made to emit light. The amount of light that is emitted by either type of display may be varied by varying the graphical content displayed on the display. Thus, reflective and transmissive displays may be used as a light source to illuminate an object for scanning purposes. In other words, light that is emitted from such a display that is then reflected off of the object may be detected and used to construct an image of the object. This may be particularly useful in the context of non-projection display screens, e.g., cell phone display screens, e-reader display screens, tablet display screens, laptop display screens, etc., allowing such devices to possess scanning functionality in addition to display functionality using the non-projection display screen.

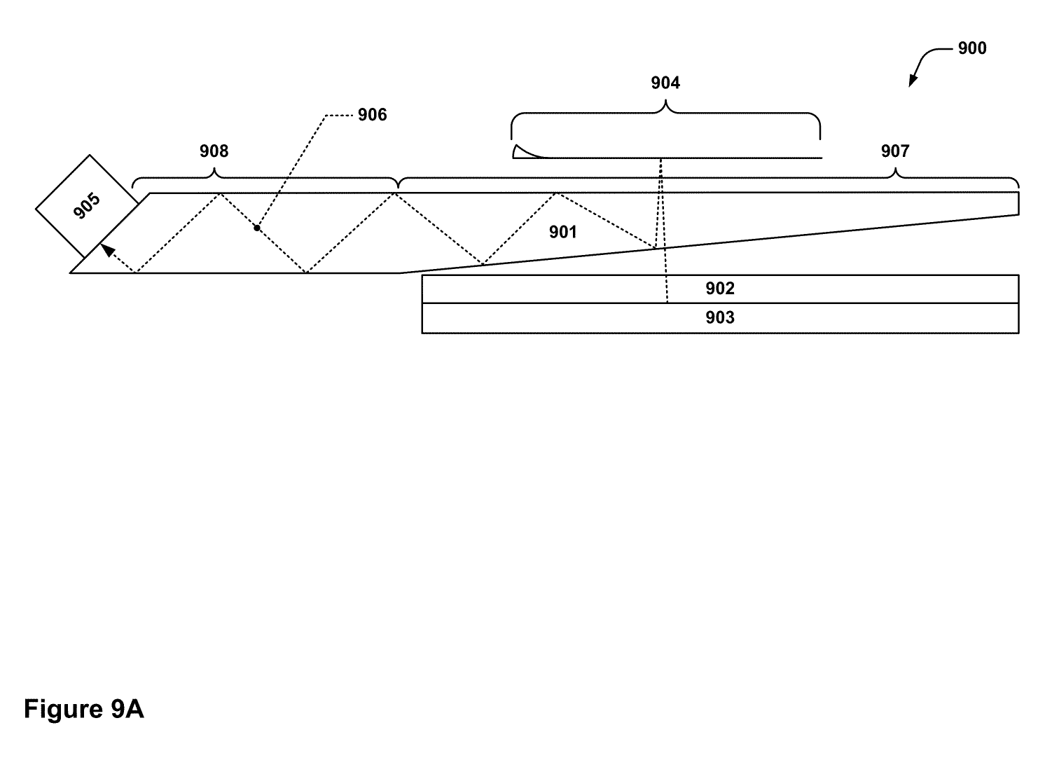

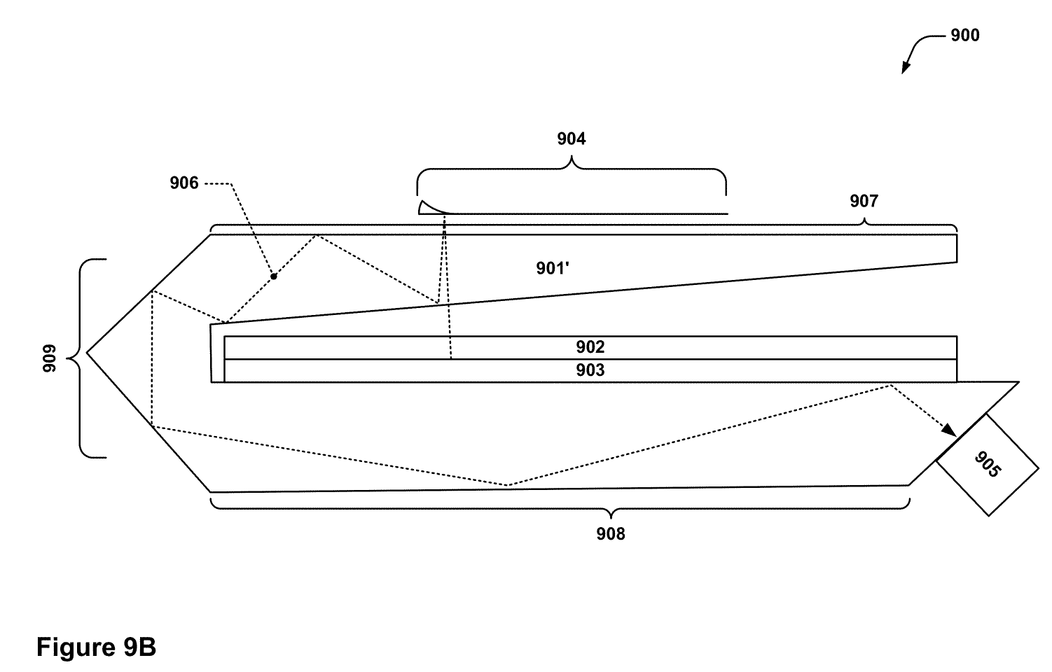

One technique that may be used to combine image acquisition capability with a non-projection display screen is to use a “wedge display.” FIG. 9A shows an example of a wedge display. As can be seen in FIG. 9A, an LCD 902 is positioned in front of a backlight 903 and behind a wedge waveguide 901. Light 906 from the backlight 903 passes through the LCD 902, through the wedge waveguide 901, and then strikes object 904. The light 906 then reflects off of the object 904 and back into the wedge waveguide 901, where it reflects off of a light-turning structure, in this illustrated implementation, the sloped bottom face of the wedge waveguide 901, and, through total internal reflection, bounces down the length of the wedge waveguide 901 and into a camera 905 located at the end of the wedge waveguide 901. The camera 905 is thus able to capture a single image of the entire display area. However, in order to do this, the wedge waveguide 901 must be substantially larger than LCD 902 since, in addition to the tapered portion of the wedge waveguide 901 that receives light reflected from the object 904, for example, light interface portion 907, the wedge waveguide 901 also includes a light propagation portion 908. The light propagation portion 908 allows an image of the complete span of the light interface portion 907 to be captured by the camera 905. In order for such an arrangement to function correctly, the camera 905 must be positioned far enough from the light interface portion 907 for the light interface portion 907 to fall entirely within the field-of-view (FOV) of the camera 905. This is because the image that the camera 905 is to capture is captured across the entire width of the light interface portion 907 (the width, in this case, referring to the dimension of the light interface portion 907 that is perpendicular to the page of the drawing). If the image is not completely within the FOV of the camera 905, then some portions of the image may not be captured and may be lost. Additionally, the field of view of the camera 905 must not be so wide that light travelling down the light propagation portion 908 and towards the camera 905 is able to escape from the light propagation portion 908 due to a breakdown in total internal reflection. While a wedge display may be used to provide a combined image display and image acquisition functionality, such a display requires significant sacrifices in terms of packaging volume and is unsuitable for use in compact electronics due to the need for the light propagation portion.

Another variant of a wedge display seeks to address some of the packaging issues present in the wedge display discussed above by “folding” the wedge waveguide back on itself. FIG. 9B shows an example of a folded wedge display. FIG. 9B depicts many structures similar to those shown in FIG. 9A. As can be seen in FIG. 9B, the LCD 902 is positioned in front of the backlight 903 and behind a wedge waveguide 901′. Light 906 from the backlight 903 passes through the LCD 902, through the wedge waveguide 901′, and then strikes the object 904. The light 906 then reflects off of the object 904 and back into the radiation interface portion 907 of the wedge waveguide 901′, where it reflects off of a light-turning structure, for example, the sloped bottom face of the wedge waveguide 901′, and, through total internal reflection, bounces down the length of the wedge waveguide 901′ and into a camera 905 located at the end of the wedge waveguide 901′. As can be seen, the wedge waveguide 901′ has a folded portion 909 that acts to reflect the light 906 such that it reverses direction entirely from the radiation interface portion 907 and the radiation propagation portion 908 and is directed back past the point where it entered the wedge waveguide 901′ and into the camera 905.

While such an arrangement does not result in the wedge waveguide 901′ having as large a footprint in the XY plane (in the context of this disclosure, the XY plane is generally defined as being parallel to a display screen, for example, LCD 902, and the Z direction is generally defined as being normal to the display screen), the wedge waveguide 901′ is still subject to the constraints regarding the image propagation portion 908 discussed above. While the folded portion 909 allows the image propagation portion 908 to be located “underneath” the LCD 902 and the backlight 903, this configuration causes the overall scanning display assembly to increase substantially in thickness, in other words, the wedge waveguide 901′ essentially doubles in thickness (it is to be understood that the term “underneath” in this disclosure with reference to a display screen is meant to refer to items located behind the display screen when the display surface of the display screen is viewed from a direction substantially normal to the display screen). In modern electronic devices, such packaging volume sacrifices are unacceptable.

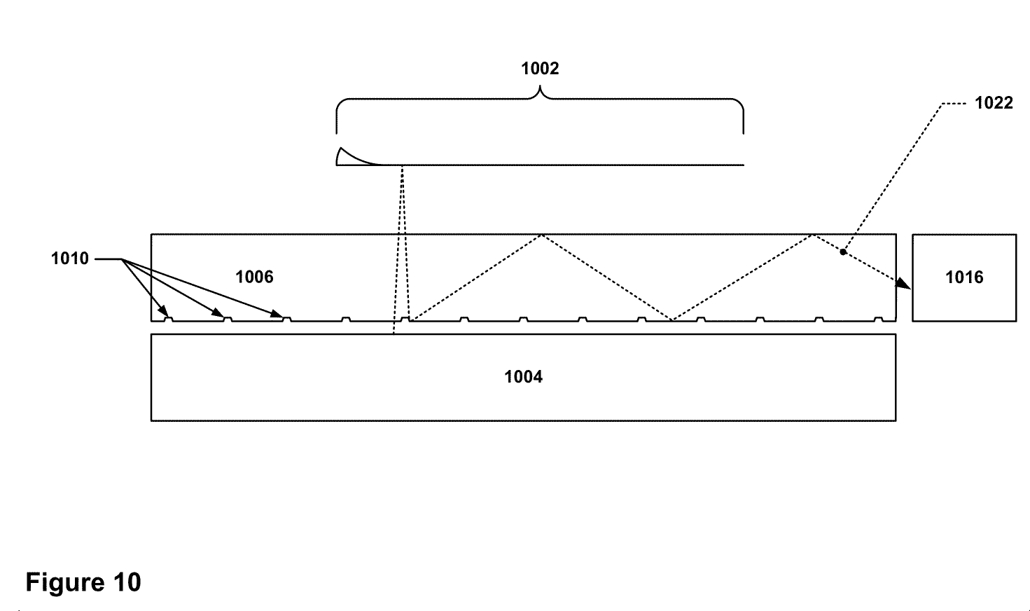

FIG. 10 shows a side view of a high-level example of a scanning display that may be used with various imaging techniques outlined herein. The scanning display shown in FIG. 10, as well as other scanning displays shown in following Figures, offer a much more compact packaging volume over, for example, the displays shown in FIGS. 9A and 9B.

FIG. 10 shows a non-projection display screen 1004 with a collection light guide 1006 overlaid atop the display surface of the non-projection display screen 1004. A light detector 1016 is located along one side of the collection light guide 1006. An object 1002 that is to be scanned may be placed atop the collection light guide 1006. The object 1002 may be placed directly on the collection light guide 1006, or may be offset from the collection light guide 1006 by some distance (as shown). While air gaps are shown between the various components in FIG. 10 to allow for ease of viewing, in actual practice, these gaps may not exist or may be much smaller than shown.

The collection light guide 1006, as well as other collection light guides discussed herein, may be a substantially planar light guide having two major surfaces, for example, a first surface that faces the non-projection display screen 1004, and a second surface that faces away from the non-projection display screen 1004. The first surface and the second surface may be substantially parallel to, and coextensive with, each other. The collection light guide 1006 also may include a number of side faces spanning between the first surface and the second surface and located about the periphery of the collection light guide.

The collection light guide 1006 may include a number of light-turning structures 1010 inside. The light-turning structures may be configured to generally allow light emitted from the non-projection display device 1004, for example, light following first light path 1022, to pass through the collection light guide 1006 and towards the object 1002, but to redirect the light that is reflected off of the object 1002 and back into the collection light guide 1006 towards the periphery of the collection light guide 1006 and into, for example, light detector 1016. Further details of such low-packaging-volume scanning displays are discussed with reference to additional Figures. As mentioned above, it is to be noted that the collection light guide 1006, as well as other collection light guides discussed in this disclosure, may be a planar light guide, in other words, the major opposing faces of the collection light guide may be generally parallel to each other, as opposed to the tapered orientation of the major faces in the wedge waveguides discussed above with respect to FIGS. 9A and 9B. The collection light guide 1006 may, as a result of the light-turning structures 1010 inside, permit more light to pass through the collection light guide 1006 from the first surface to the second surface than from the second surface to the first surface.

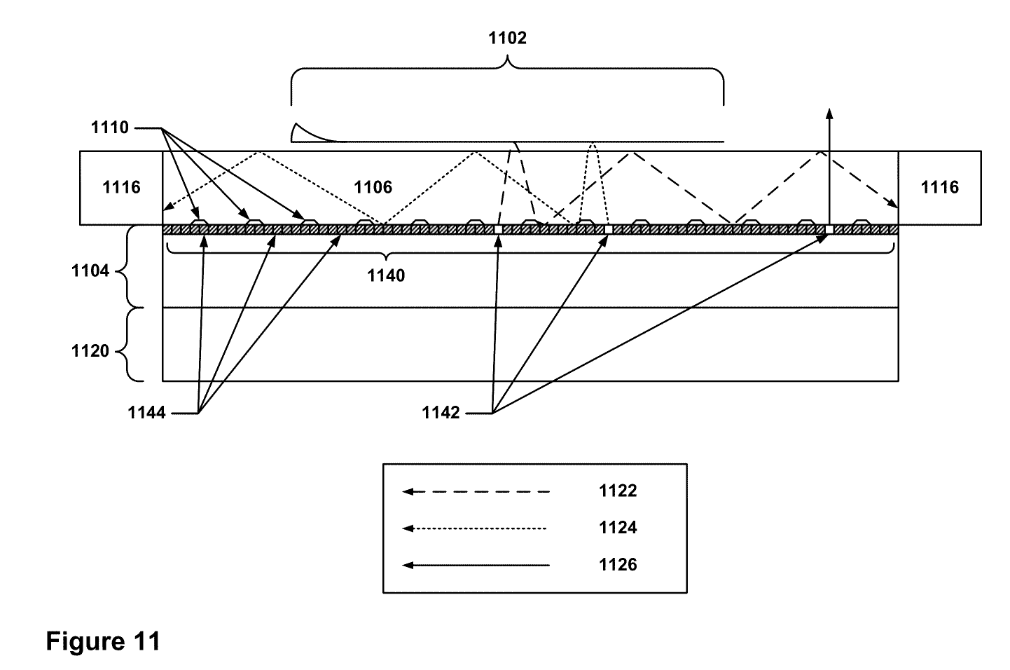

FIG. 11 shows a side view of a high-level example of a scanning display with a backlit liquid crystal display (LCD) that may be used with various imaging techniques outlined herein. In this example, a non-projection display screen 1104 is shown with a collection light guide 1106 overlaid atop the display surface of the non-projection display screen 1104. In this particular implementation, the non-projection display screen 1104 is a transmissive LCD screen that is illuminated via a backlight 1120. Two light detectors 1116 are located along opposing sides of the collection light guide 1106. An object 1102 that is to be scanned may be placed atop the collection light guide 1106.

Also shown in FIG. 11 are a number of pixels 1140, including dark pixels 1144 and bright pixels 1142. In this example, three of the pixels 1140 are emitting, and in this particular example, transmitting light. That is bright pixels 1142 are emitting light. As can be seen, light from the left-most bright pixel 1142 may follow a first light path 1122. The first light path 1122 may pass through the collection light guide 1106 largely unhindered, strike the object 1102, be reflected off of the object 1102, and travel back into the collection light guide 1106. The re-entrant light of light path 1122 may then strike a light-turning structure 1110 inside of the collection light guide 1106 and be redirected towards the periphery of the collection light guide 1106 via a total internal reflection mechanism, where the light may exit the collection light guide 1106 and strike one of the light detectors 1116, in this case, the right light detector 1116. However, light from the left most bright pixel also may be reflected in other directions, for example, towards the left side of the collection light guide 1106. Thus, it is possible for each of the light detectors 1116 to detect a portion of the light that is reflected off of the object 1102 and into the collection light guide 1106.

Similarly, the light emitted by the middle bright pixel 1142 may be reflected off of the object 1102 and may follow a second light path 1124 into, for example, the left light detector 1116.

In contrast, the light emitted by the rightmost bright pixel 1142 may follow the third light path 1126 and exit the collection light guide 1106 and may not encounter the object 1102 since the object 1102 is not located above the rightmost bright pixel 1142. Thus, the light emitted from the right-most bright pixel 1142 in this example may follow the third light path 1126 and not be reflected back into either of the light detectors 1116.

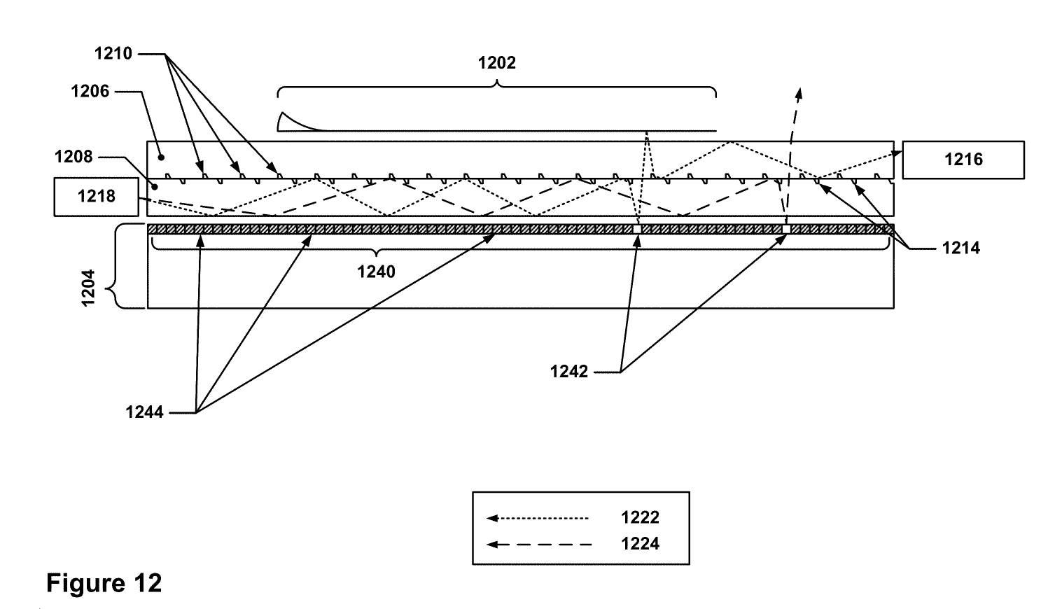

FIG. 12 shows a side view of a high-level example of a scanning display with a front-lit reflective display that may be used with various imaging techniques outlined herein.

In this example, a non-projection display screen 1204 is shown with a front light guide 1208 interposed between a collection light guide 1206 and the display surface of the non-projection display screen 1204. In this particular implementation, the non-projection display screen 1204 is a reflective display screen, for example, an IMOD display screen, which is illuminated by a light source 1218 via the front light guide 1208. A light detector 1216 is located along one side of the collection light guide 1206. An object 1202 that is to be scanned may be placed atop the collection light guide 1206.

Also shown in FIG. 12 are a number of pixels 1240, including dark pixels 1244 and bright pixels 1242. In this example, two of the pixels 1240 are emitting, and in this particular case, reflecting light. That is, bright pixels 1242 are emitting light. The mechanism for such light emission in this implementation is rather different from the mechanism used in FIG. 11. For example, in FIG. 11, the non-projection display screen 1104 acts as a mask that blocks light from the backlight 1120 from shining through the dark pixels 1144 and allows light from the backlight 1120 to shine through the bright pixels 1142. In the implementation shown in FIG. 12, the entire array of pixels 1240 is illuminated using the front light guide 1208 and the light source 1236. Light from the front light guide 1208, however, is generally only reflected off of the non-projection display screen 1204 and towards the object 1202 or the ambient environment by the bright pixels 1242. Little or no light is reflected from the dark pixels 1244.

The front light guide 1208 may, in many ways, be similar in construction to the collection light guide 1206. For example, the front light guide also may include two substantially parallel and coextensive major surfaces similar to the first surface and the second surface of the collection light guide 1206. To avoid confusion, these surfaces may, with respect to the front light guide 1208, be referred to herein as the “third surface” and the “fourth surface.” The third surface may face the non-projection display screen, and the fourth surface may face away from the non-projection display screen.

Thus, for example, light may be emitted from the light source 1218 and into the front light guide 1208, where it may travel along the length of the front light guide 1208, either directly or via total internal reflection. At some point, the light may strike a front light light-turning structure 1214 that may cause the light to exit the front light guide 1208 and strike the pixels 1240. If the light strikes a dark pixel 1244, little, if any, of the light may be reflected back out of the scanning display 1200. If the light strikes a bright pixel 1242, the light may be reflected back out through the front light guide 1208 and the collection light guide 1206 and may strike, if present, the object 1202. The light may then be reflected off of the object 1202 and travel back through the collection light guide 1206, where it may be redirected by a light-turning structure 1210 included within the collection light guide 1206 so that the light travels towards the periphery of the collection light guide. The redirected light may then be detected by the light detector 1216 at the periphery of the collection light guide 1206.

As can be seen in this example, light following a first light path 1222 may be emitted from the light source 1218, travel through the front light guide 1208, and strike one of the front light light-turning structures 1214. The light may then be reflected off of the front light-turning structure 1214, and directed towards the non-projection display screen 1204. Upon striking the left bright pixel 1242, the light may continue to follow the first light path 1222 back through the front light guide 1208 and the collection light guide 1206, and may then exit the collection light guide 1206 and strike the object 1202. The light may reflect off of the object 1202, and then travel back into the collection light guide 1206, where it may strike one of the light-turning structures 1210 and be redirected towards the periphery of the collection light guide 1206. Upon exiting the periphery of the light-turning guide 1206, the light may be detected by the light detector 1216 positioned at the periphery of the collection light guide 1206.

Similarly, light following a second light path 1224 may be emitted from the light source 1218, travel through the front light guide 1208, and strike one of the front light-turning structures 1214. The light may then be reflected off of the front light-turning structure 1214, and directed towards the non-projection display screen 1204. Upon striking the right bright pixel 1242, the light may continue to follow the second light path 1224 back through the front light guide 1208 and the collection light guide 1206, and may then exit the collection light guide 1206. At this point, the behavior of the light following the second light path 1224 may diverge from the behavior of the light following the first light path 1222. For example, the light following the light path 1224 may exit the collection light guide 1206 and not encounter the object 1202 since the object 1202 is not located above the right bright pixel 1242. Thus, the light emitted from the right bright pixel 1242 may simply follow the second light path 1224 and not be reflected back into the light detector 1216.

Generally speaking, the scanning displays disclosed in this disclosure may be implemented using either backlit or front-lit displays as needed using the requisite parts (for example, for backlit displays, a transmissive display and backlight, and for front-lit displays, a reflective display, a front light guide and light source(s)). The light guides used, for example, collection light guides and, when appropriate, front light guides, may be made from clear plastics or glass, and may be composite structures featuring materials with different refractive indexes in various locations in order to produce light-turning structures.

As can be seen, the light detectors in the pictured implementations may be positioned in close proximity to the non-projection display screen, for example, abutting the non-projection display screen. This is possible because the light detectors used in various implementations of the scanning displays discussed herein may be single-pixel, or low-resolution detectors. For example, in some implementations, the resolution of the light detectors may be substantially lower than the resolution of the image that will be captured of the object. In some implementations, the resolution of the light detectors can be one or more orders of magnitude less in resolution, or several orders of magnitude less in resolution. In contrast, more complex light detectors, such as CCD pixel arrays used with digital cameras, require complex optical/lensing systems in order to project a real image onto the image sensor. Such complex optical/lensing systems may, for example, be used with the wedge displays shown in FIGS. 9A and 9B.

As noted, the light detectors of the scanning displays discussed herein may be simple, single element light detectors. Such a light detector may be configured to measure the average amount of illumination or luminance striking the light detector. Thus, in a scanning display with a single light detector, only one luminance value may be detected at any given moment. In a scanning display with, for example, four light detectors, for example, one along each side of a rectangular collection light guide, four luminance values may be detected at any given moment. Various types of light detectors may be used with such scanning display implementations, including CMOS, CCD, photodiodes, photoresistors, etc. While lensing is not required to be used with such light detectors in the implementations discussed herein, some lensing may be desired in some implementations to increase light collection efficiency. In some implementations, it may be unnecessary for such lensing to project a real image of an object being imaged onto the light detector(s) since the light detector(s) used would generally be of too low a resolution to directly capture any detail in the real image.

Various techniques for using such scanning displays and light detectors are discussed later in this document.

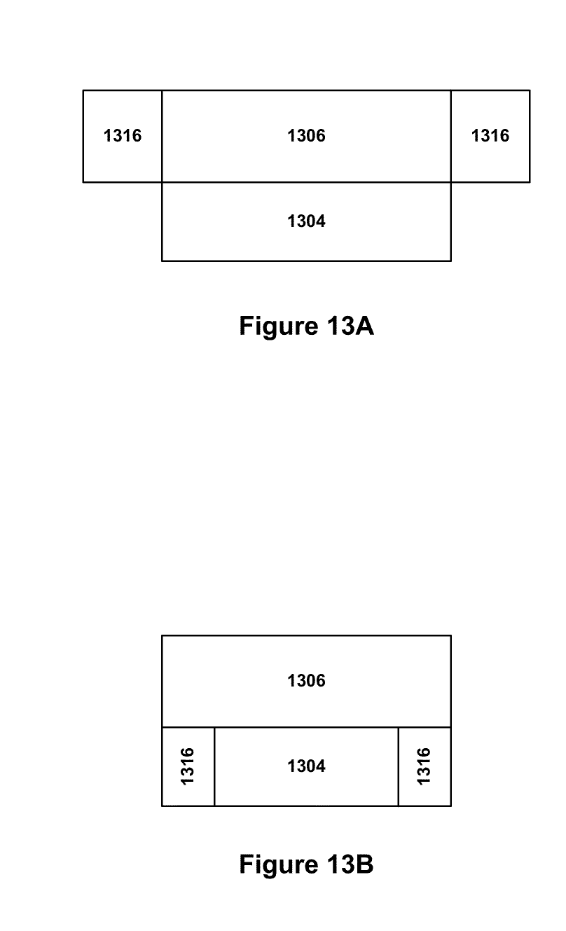

Because lensing is not required for the scanning displays of FIGS. 10 through 12 and the additional scanning displays discussed below, a scanning display designer has considerable flexibility with regard to placement of the light detectors. FIGS. 13A and 13B depict some of the light detectors placement options available.

FIG. 13A shows a side view of an example of one arrangement of a non-projection display screen, a collection light guide, and edge-located light detectors for a scanning display. In this implementation, light detectors 1316 may be placed along peripheral faces of the collection light guide 1306 and a non-projection display screen 1304 may be located beneath the collection light guide 1306. In this implementation, the light detectors 1316 may detect light that is experiencing total internal reflection when it exits the peripheral side faces of the collection light guide 1306. In the implementation shown, the faces through which the light travels to reach the light detectors 1316 are faces that have edges that define a portion of the second surface, in other words, the major surface of the collection light guide that faces away from the non-projection display screen 1304. This allows components associated with the non-projection display screen 1304, or the non-projection display screen 1304 itself, to extend beyond the light detectors 1316, which may be desirable if the non-projection display screen 1304 includes, for example, leadframes or die material that would protrude from the sides of the non-projection display screen 1304 and into the volume where the light detectors 1316 may be mounted in some configurations (see FIG. 13B). In such implementations, the collection light guide 1306 may be substantially coextensive with the non-projection display screen 1304 (or at least with the active display region of the non-projection display screen 1304).

FIG. 13B shows a side view of an example of one arrangement of a non-projection display screen, a collection light guide, and light detectors located underneath the collection light guide for a scanning display. In this implementation, the light detectors 1316 may be placed about the periphery of the bottom surface of the collection light guide 1306 and a non-projection display screen 1304 may be located beneath the collection light guide 1306. The bottom surface of the collection light guide 1306 where the light detectors 1316 are located may be treated with a refractive index matching material between the collection light guide 1306 and the light detectors 1316, or with a diffusion barrier or other surface treatment that interferes with the total internal reflection of light incident on the bottom surface of the collection light guide 1306 and causes the light to pass through the bottom surface and into the light detectors 1316. Such implementations may be useful in situations where, for example, it is desirable for the collection light guide 1306 to be an unbroken surface, for example, if the collection light guide 1306 also doubles as a cosmetic element for the exterior of the scanning display. The orientation of the light detectors in FIG. 13B is may be orthogonal to the orientation of the light detectors in FIG. 13A. For example, the primary axis of light detection of the light detectors 1316, in other words, the axis along which the sensitivity of the light detector is greatest, may be generally orthogonal to the first surface of the collection light guide 1306 in the configuration shown in FIG. 13B, whereas the primary axis of light detection of the light detectors 1316 may be generally orthogonal to the side faces of the light collection guide 1306 and parallel to the first surface in the configuration shown in FIG. 13A.

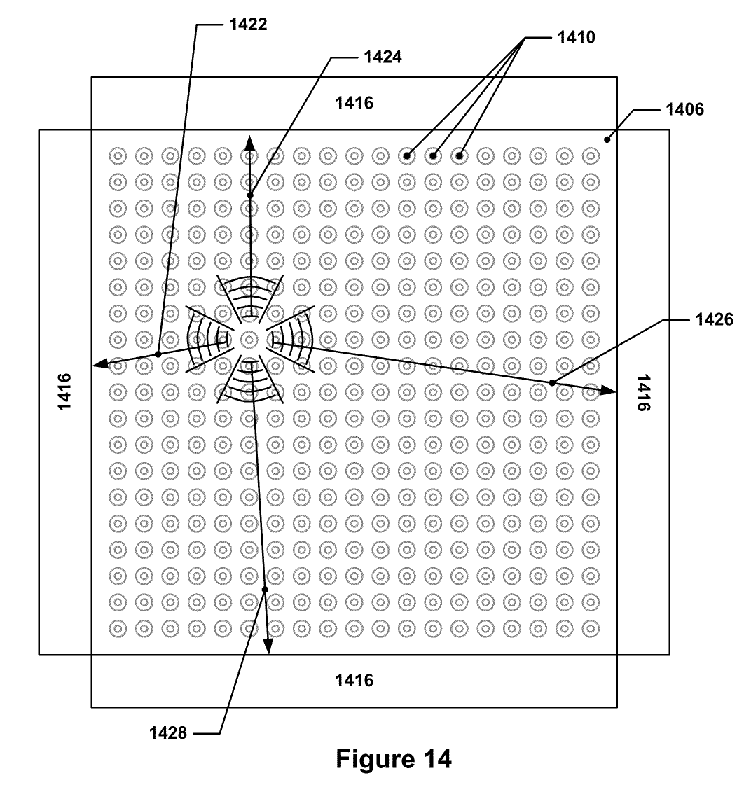

FIG. 14 shows a plan view of an example of light detectors and a planar collection light guide with omni-directional light-turning features for an example scanning display. In this implementation, four light detectors 1416 are arranged about the periphery of a planar, omni-directional collection light guide 1406. The light detectors may not extend along the entire edge of the collection light guide 1406, but may instead only extend along a portion of the edge of collection light guide 1406. Primary light-turning structures 1410 are arrayed across one face of the collection light guide 1406. The light-turning structures 1410, in this example, are generally shaped as conical frustums, and may direct a light ray striking the light-turning structures 1410 towards any of the four light detectors 1416 depending on where the light ray strikes the light-turning structure 1410. For example, a light ray reflected off of a scanned object (not shown) may strike various portions of one of the light-turning structures 1410 and may then travel, via total internal reflection, within the collection light guide 1406 to the periphery of the collection light guide 1406, where the light may exit the collection light guide and be detected by the light detectors 1416. It is to be understood that while the light detectors 1416 shown in FIG. 14 and in other Figures in this document are shown as extending across the entire edge of the collection light guide 1406, in practice, such may not be the case. For example, the light detectors 1416 may each be individual photodiodes and may be approximately 1 or 2 mm in size (or even smaller).

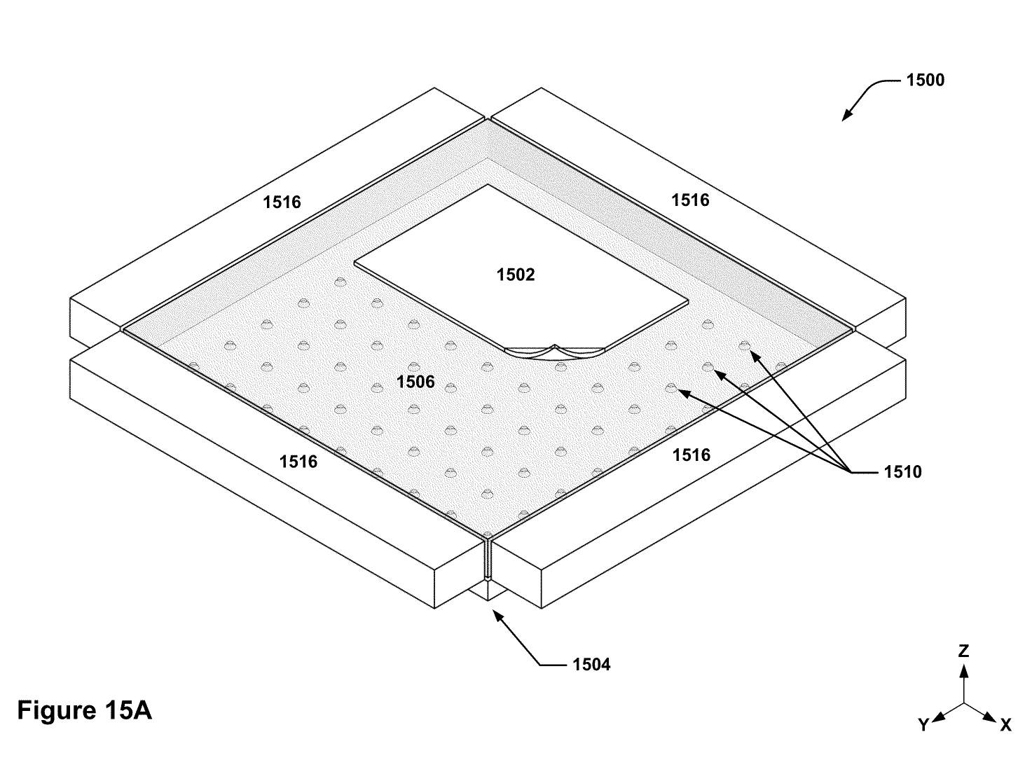

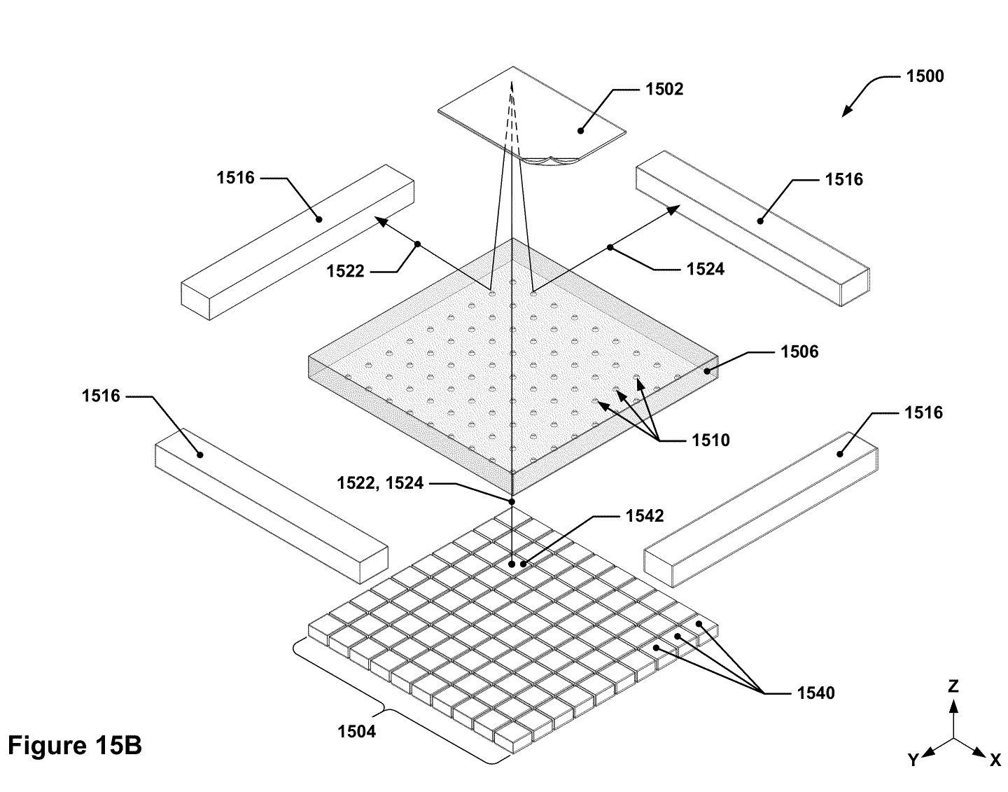

FIG. 15A shows an isometric view of an example scanning display with edge-located light detectors and a planar collection light guide with omni-directional light-turning features. As can be seen, scanning display 1500 includes an omni-directional, planar collection light guide 1506 that has light detectors 1516 located on four sides. A non-projection display screen 1504 is located underneath the collection light guide 1506, and a plurality of light-turning structures 1510, for example, conical frustum light-turning structures, are located on the face of the collection light guide 1506 facing the non-projection display screen 1504. An object 1502 has been placed on top of the scanning display 1500 in order to be scanned.

FIG. 15B shows an isometric exploded view of the example scanning display of FIG. 15A. Visible in greater detail in FIG. 15B is the non-projection display screen 1504, which, in this implementation, includes a 10×10 array of pixels 1540. In this example, light paths are shown indicating potential directions of light travel for light emitted from a bright pixel 1542. As can be seen, the light may travel along the first light path 1522, through the collection light guide 1506, and strike the object 1502. The light may then reflect off of the object 1502 and back into the collection light guide, where it may strike a light-turning structure 1510 and be redirected towards the periphery of the collection light guide 1506. Upon reaching the periphery of the collection light guide 1506, the light may exit the collection light guide 1506 and strike one of the light detectors 1516. Other light emitted from the bright pixel 1542 may follow a different path, for example, second light path 1524, and may be detected by another light detector 1516 located on a different side of the collection light guide 1506. Note that, in FIG. 15B, the redirected light is not shown as experiencing total internal reflection within the collection light guide 1506, although such may be the case. Also note that, for ease of viewing, the first light path 1522 and the second light path 1524 are shown in a “stretched” form necessitated by the exploded nature of the view, and may, in practice, be different from the light paths shown.

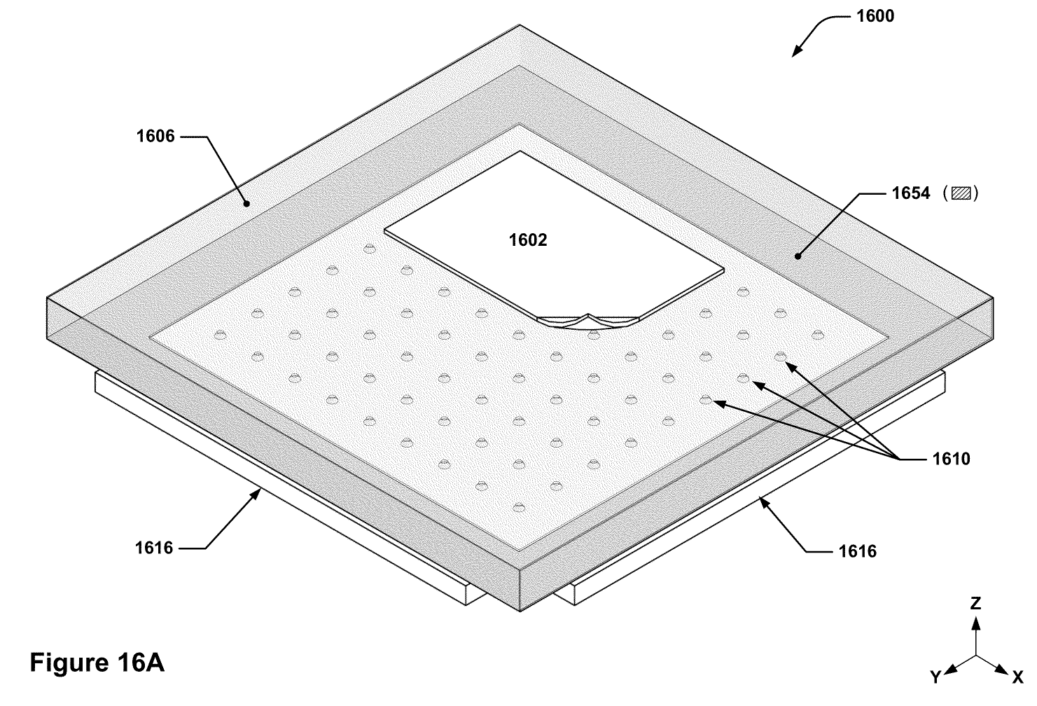

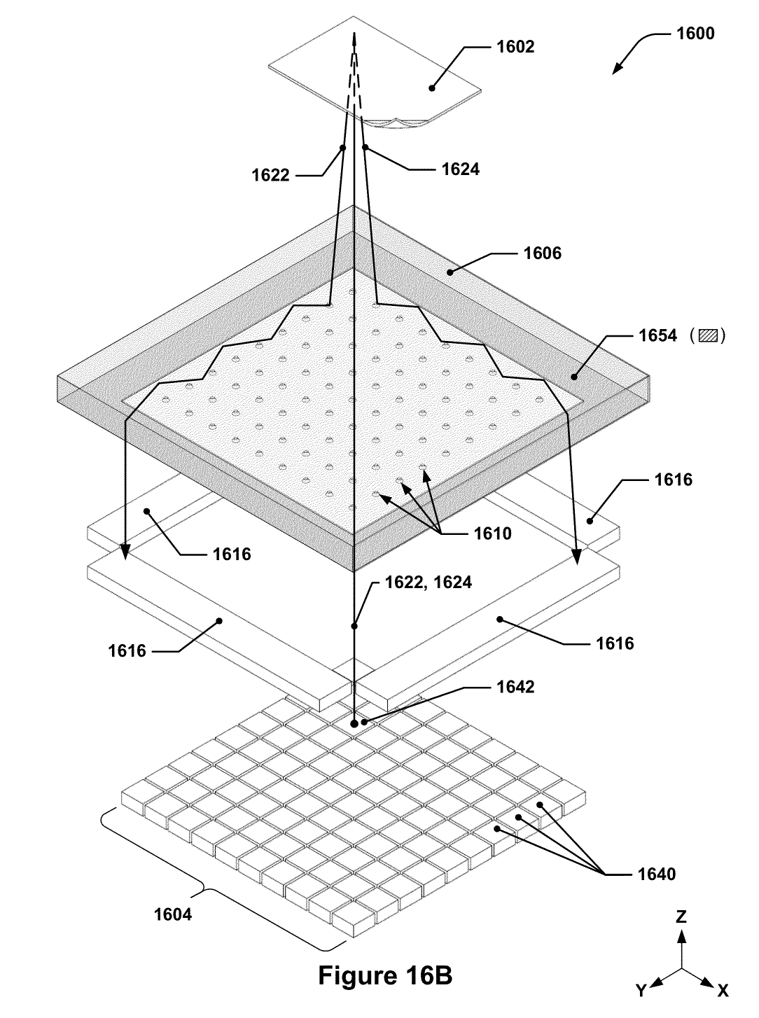

FIG. 16A shows an isometric view of an example scanning display with a planar collection light guide featuring omni-directional light-turning features and light detectors located underneath the collection light guide. As can be seen, four light detectors 1616 are arranged underneath, and about the periphery of, an omni-directional, planar collection light guide 1606. A non-projection display screen 1604 (not visible in this view) is located underneath the collection light guide 1606, and a plurality of light-turning structures 1610, for example, conical frustum light-turning structures, are located on the face of the collection light guide 1606 facing the non-projection display screen 1604. An object 1602 has been placed on top of the scanning display 1600 in order to be scanned.

FIG. 16B shows an isometric exploded view of the example scanning display of FIG. 16A. Further visible in FIG. 16B is the non-projection display screen 1604, which, in this implementation, includes a 10×10 array of pixels 1640. In this example, light paths are shown indicating potential directions of light travel for light emitted from a bright pixel 1642. As can be seen, the light may travel along the first light path 1622, through the collection light guide 1606, and may then strike the object 1602. The light may then reflect off of the object 1602 and back into the collection light guide, where it may strike a light-turning structure 1610 and be redirected towards the periphery of the collection light guide 1606. Upon reaching the periphery of the collection light guide 1606, the light may exit the collection light guide 1606 in a peripheral region that includes, for example, a diffusion barrier 1654 that frustrates the total internal reflection of the light and causes light incident to the diffusion barrier to exit the collection light guide, and strike one of the light detectors 1616. Other light emitted from the bright pixel 1642 may follow a different path, for example, second light path 1624, and may be detected by another light detector 1616 located on a different side of the collection light guide 1606. Note that, in FIG. 16B, the redirected light is shown as experiencing total internal reflection within the collection light guide 1606. Also note that, for ease of viewing, the first light path 1622 and the second light path 1624 are shown in a “stretched” form necessitated by the exploded nature of the view, and may, in practice, be different from the light paths shown.

In the implementations shown, for example, in FIGS. 15A-16B, four light detectors are used to detect the amount of light redirected towards the periphery of a collection light guide. Other implementations may feature only a single light detector, or any other number of light detectors and the light detectors may be arranged to cover many different positions and areas along the periphery of the collection light guide. These implementations may, however, all share a common trait of yielding a single measured illumination value for any given combination of object/object placement and pattern of bright and dark pixels used to illuminate the object. The specific geometry of the collection light guide used may be tuned in particular ways depending on the number of light detectors used. Omni-directional light-turning structures have the advantage of redundancy such that multiple light detectors may be used to take a measurement, however, it is understood that the light-turning features may not be omni-directional and may be unidirectional and configured to redirect the light toward one or more, but not all, of the sides of the light collection guide. For example, if a single light detector is used, the collection light guide may be configured with light-turning structures that are largely unidirectional and direct light predominantly towards the portion of the periphery of the collection light guide where the light detector is located.

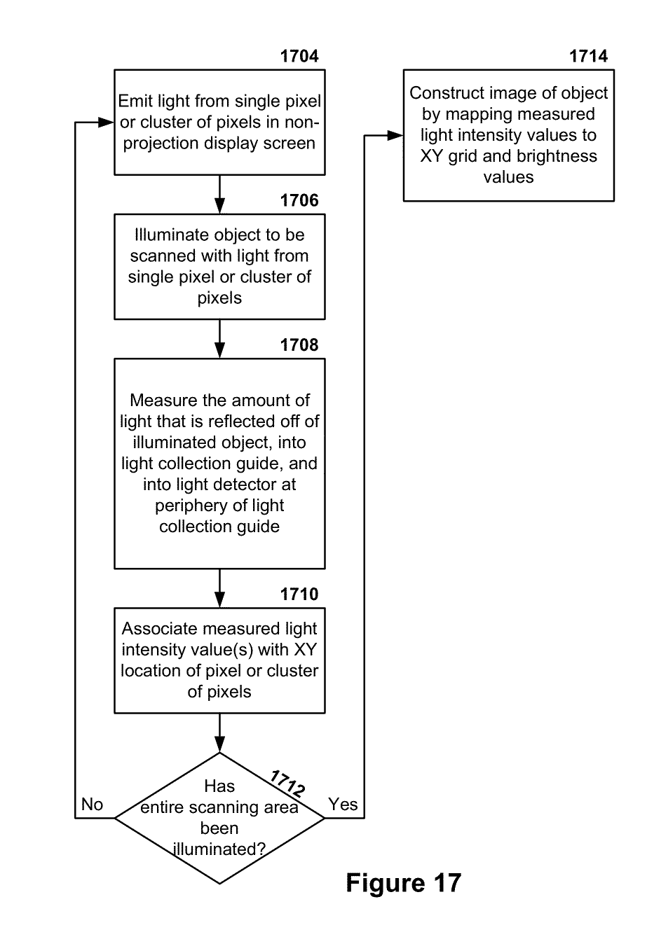

Implementations that produce a single measurement of detected light intensity may, for example, be used to obtain scanned images of an object illuminated by the scanning display through a single-pixel (or cluster of pixels) raster scan. FIG. 17 shows a block diagram of an example technique for using a scanning display as described herein to perform raster pixel scanning image acquisition. In block 1704, the non-projection display screen of the scanning display may be instructed to illuminate a pixel or cluster of pixels. The intensity and color of the illumination may be varied depending on the location of the pixel or cluster of pixels. In block 1706, the light from the pixel or cluster of pixels may be used to illuminate an object to be scanned. In block 1708, light from the pixel or cluster of pixels that is reflected off of the object, back into a collection light guide of the scanning display, and then redirected into one or more light detectors at the periphery of the collection light guide may be measured. In block 1710, the light intensity or luminance measured by the light detector(s) may be associated with the XY location of the pixel or cluster of pixels that produced the light that reflected off of the object and produced the measured light intensity or luminance values. In block 1712, a determination may be made as to whether the entire scanning area has been illuminated. The entire scanning area may, in practice, be less than the entire scannable area, in other words, only a subregion of the scanning display may be scanned depending on the application. For example, if an article that is smaller than the non-projection display screen is to be scanned, only a subset of the non-projection display screen may need to be illuminated. If further illumination is required, the technique may return to block 1704, and a new pixel or cluster of pixels may be illuminated and luminance/intensity values detected by the light detector(s) may be associated with the XY location of each such pixel or pixel cluster illumination. In some implementations, the pixels or clusters of pixels may be illuminated in a raster scan mode, for example, row by row and then sequentially column by column within each row, or may be illuminated in some other sequence, for example, randomly.

After illumination of the object is complete, in block 1714, an image of the object may be constructed by mapping the measured light intensity/luminance values measured by the light detector(s) to the XY locations associated with each measurement. Such a technique generally requires that at least one light intensity/luminance measurement be taken and used for each pixel in the constructed image.

Another technique that may be used to construct an image of a scanned object using scanning displays such as those shown in FIGS. 15A-16B may be compressive sampling. Compressive sampling is a technique that allows compressible signals, of which naturally-occurring images are one example, to be recovered from far fewer samples than required by traditional methods. Compressible signals have a sparse or approximately sparse representation in some linear-algebra basis. A sparse representation has mostly zero coefficients. Naturally occurring images are approximately sparse in, for example, wavelet bases, which allows for their significant compression with modern image compression algorithms, such as for example, JPEG-2000. In compressive sampling, the signal to be sampled (in this case, the image of the object to be scanned) is projected (in the linear-algebra sense) onto a basis of mutually-incoherent vectors, which are also incoherent with the sparse-basis associated with the signal to be sampled. For example, pseudo-random binary images are one such set of basis vectors. The results of all the projections are collected. To recover the signal, an optimization problem may be solved using a linear programming algorithm that will find, with high probability, the sparsest possible signal which satisfies the constraint that the signal matches the collected projections within a given tolerance. Compressive sampling (also often referred to as compressed sensing, compressive sampling, or sparse sampling) techniques are well known in the art of signal processing and related fields. Papers describing these techniques are readily available to those of ordinary skill in the art, including illustrative examples such as Emmanuel J. Candes, “Compressive sampling,” in Proc. Int. Cong. Mathematicians, Madrid, Spain, vol. 3, 2006, pp. 1433-1452 and Candes, Emmanuel J.; Wakin, M. B., “An Introduction To Compressive Sampling,” Signal Processing Magazine, IEEE, vol. 25, no. 2, pp. 21-30, March 2008, and to the original reference, Emmanuel J. Candès, Justin Romberg, and Terence Tao, “Robust uncertainty principles: Exact signal reconstruction from highly incomplete frequency information,” IEEE Transactions on Information Theory, 52(2): 489-509, February 2006, all of which are hereby incorporated by reference in their entireties. Similarly, compressive sampling techniques have also been described for image processing and are readily available to those of ordinary skill in the art, including, as an example, the paper “Single-Pixel Imaging via Compressive Sampling” by Duarte et al. for further discussion of compressive sampling techniques used for image sampling (Marco F. Duarte, Mark A. Davenport, Dharmpal Takhar, Jason N. Laska, Ting Sun, Kevin F. Kelly, and Richard G. Baraniuk, Single-Pixel Imaging via Compressive Sampling, IEEE Signal Processing Magazine, March 2008, at 83, pages 83-91), all of which is hereby incorporated by reference in its entirety.

This technique allows for an image of an object illuminated by a series of different compressive image patterns to be constructed from single-pixel measurements of light reflected from the object in response to each such compressive image pattern illumination. The compressive image patterns may, for example, be generated by producing a pseudorandom pattern of bright and dark pixels. The summation of the light detected from across the collection light guide by each light detector acts as a mathematical projection of the image of the object onto the compressive image pattern. To construct, for example, a 100-pixel image of an object, approximately 10 different compressive image patterns may be created and used to illuminate the object, one at a time. In conjunction with each such illumination by one of the compressive image patterns, the amount of light from the compressive image pattern illumination that is reflected from the object and into the light detector or light detectors about the periphery of the collection light guide of a scanning display may be measured and associated with the corresponding compressive image pattern. After the required number of different compressive image patterns, for example, 10 patterns in this scenario, have been displayed and intensity/luminance data for each such compressive image pattern associated with the corresponding compressive image pattern, the resulting compressive image pattern/luminance/intensity pairings may be processed to construct, for example, a 100-pixel image of the object using compressive sampling techniques.

The scanning displays discussed herein utilize compressive sampling techniques in conjunction with planar light guides with light-turning features and one or more light detectors to realize a display unit with image scanning capabilities that may be presented in a very compact packaging volume and without requiring precise optical element alignment as is required of image capture solutions utilizing a conventional optical camera system. Since optical lenses are not required in this technique, unlike conventional camera and scanning systems, the disclosed implementations may be achieved using a very thin form factor. By contrast, conventional camera-based systems using lenses require distances to project images of the object to be scanned due to the constraints placed upon such systems by the focal lengths of the lenses involved in such conventional systems.

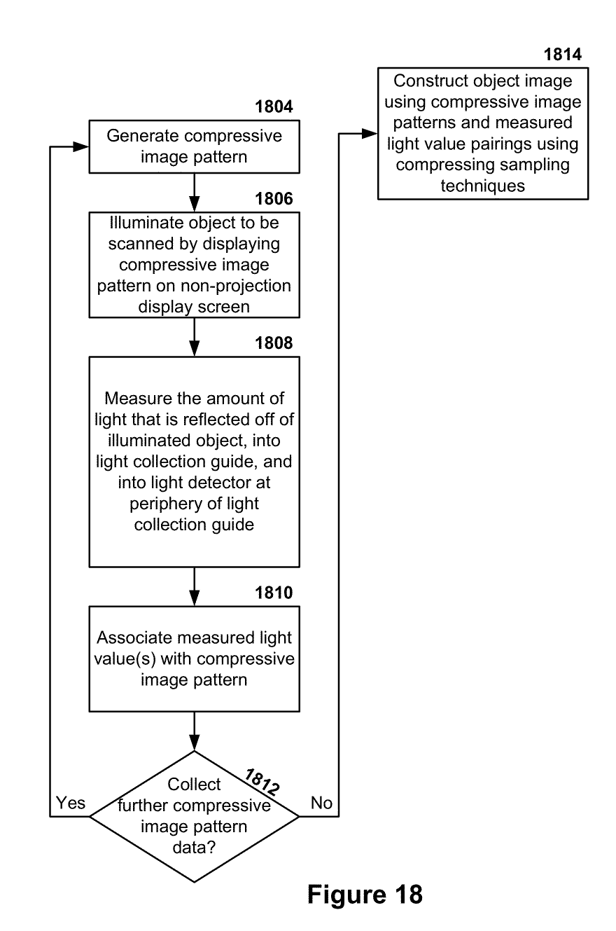

FIG. 18 shows a block diagram of an example technique for using a scanning display as described herein to perform compressive sampling image acquisition. In block 1804, a plurality of compressive image patterns may be generated. These images may be generated by a pseudorandom number generator algorithm (also called a deterministic random bit generator, or DRBG), such as, the commonly-used Mersenne Twister algorithm, and a known starting seed. The number of samples from the DRBG may be equal to the number of pixels in the image pattern times the number of compressive image patterns, for example, the bright/dark value for each pixel in each image pattern may be determined using the output from the DRBG. In other implementations, however, a DRBG may represent a string of ones and zeros, each of which may correspond to the brightness/darkness value for a single pixel in an image pattern. Other image pattern construction techniques may be used as well. The generated images may be cached or may be generated at run time. In general, the number of image patterns generated may be approximately one tenth of the number of pixels desired in the image that will be captured of the object using compressive sampling, but could vary depending on the desired precision of the constructed image. The compressive image patterns used should all be different from each other for a given image capture session (duplicate image patterns could be used as well, but, in some circumstances, these may not contribute meaningful additional data beyond the data measured in association with the presentation of the first such image pattern).

In block 1806, a compressive image pattern may be displayed on the non-projection display screen of the scanning display and the light emitted from the non-projection display screen as a result the display of the compressive image pattern may be used to illuminate the object to be scanned. In block 1808, a measurement or measurements of the amount of light from the compressive image pattern that is displayed on the non-projection display screen, reflected off of the object and into a collection light guide associated with the scanning display, and then detected by one or more light detectors placed about the periphery of the collection light guide may be made. In block 1810, each such measurement may be associated with the particular compressive image pattern that produced the intensity/luminance measurement.

In block 1812, a determination may be made as to whether further compressive image pattern illumination data is required. If additional compressive image patterns in the plurality of compressive image patterns generated in block 1804 have not yet been displayed, then the technique may return to block 1804, and a different compressive image pattern may be displayed.

Block 1814 may occur after all of the desired compressive image patterns have been used to illuminate the object to be scanned, and after the resulting light intensity/luminance associated with each such compressive image pattern display/illumination and detected by the light detector(s) has been measured. In block 1814, the intensity/luminance measurement/compressive image pattern pairings may be processed using compressive sampling techniques.

In the discussions above, the collection light guides used have been largely omni-directional. In other implementations, however, the collection light guide may be configured to segregate redirected light based on, for example, the XY location of where light reflected from a scanned object enters the collection light guide. This may allow for situations in which multiple light detectors may be used, and each such light detector may be used to detect light entering a particular area of the collection light guide. This may allow for the raster scanning techniques and the compressive sampling techniques described above to be implemented, for example, in parallel over subsections of the scanning display.

For example, a collection light guide may be divided into four quadrants, each associated with a different light detector located along the periphery of the collection light guide. Such an implementation may require the use of directional light-turning structures such that light falling into each quadrant is directed in a different direction and towards a different light detector or detectors.

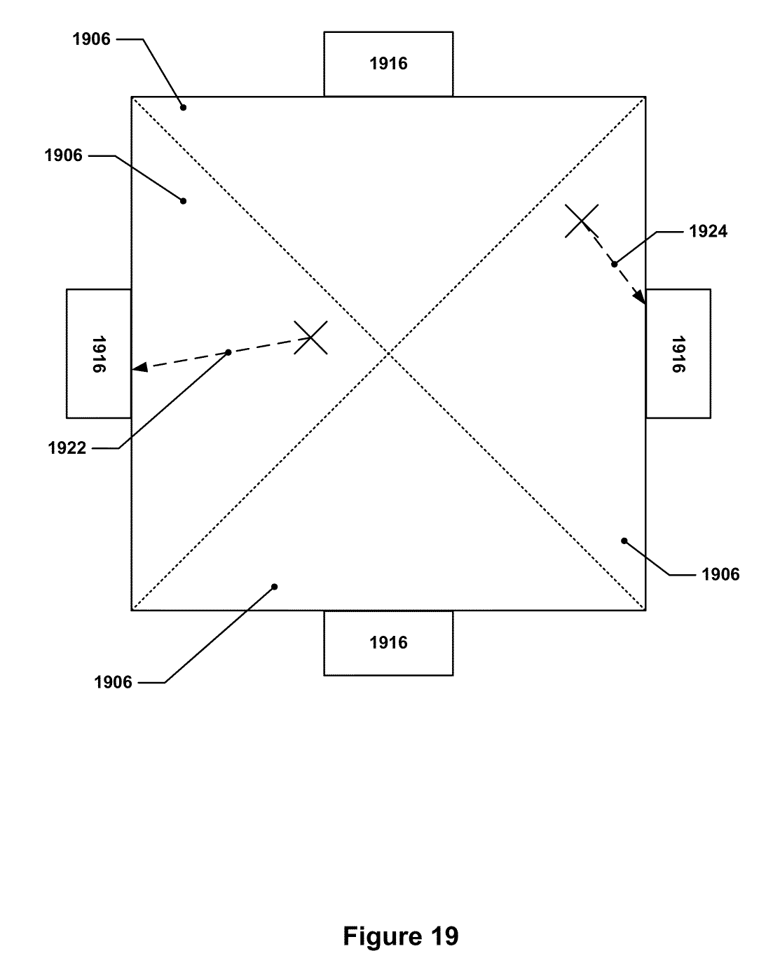

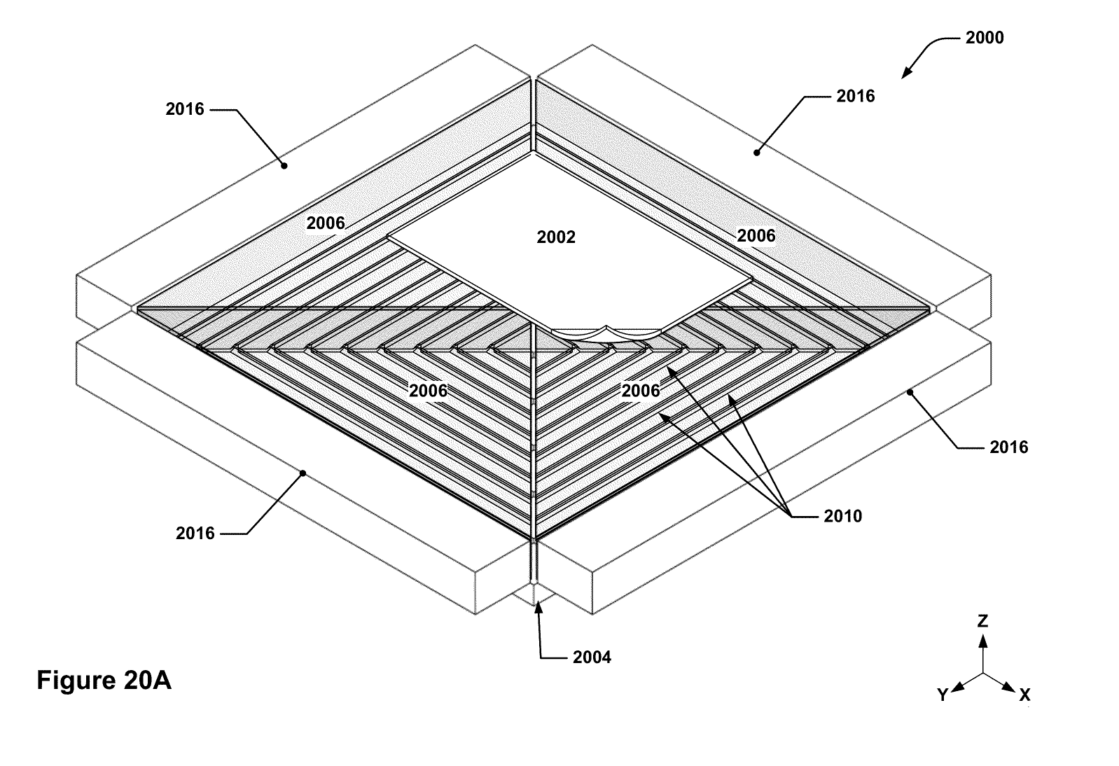

FIG. 19 shows a plan view of an example planar collection light guide with directional light-turning structures. In FIG. 19, two light transmission paths (first light path 1922 and second light path 1924) are shown; each light path is generally normal to the page of FIG. 19 upon entry into a collection light guide 1906. After entering the collection light guide 1906, the light following the first light path 1922 and the second light path 1924 may encounter directional light-turning structures that re-direct the light along in different directions depending on which quadrant the light falls within.

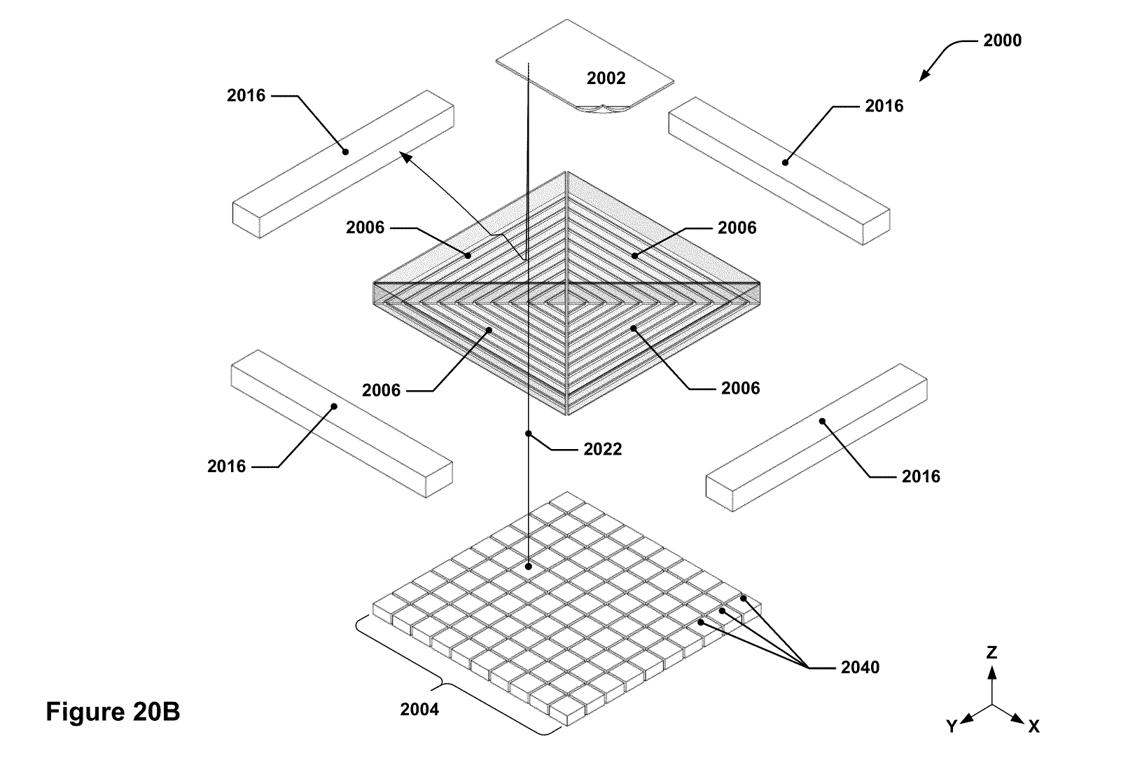

FIG. 20A shows an isometric view of an example scanning display with a planar collection light guide with directional light-turning structures. Visible in FIG. 20A are four light detectors 2016, a collection light guide 2006, and a non-projection display screen 2004 that are included in a scanning display 2000. Also visible in FIG. 20A is an object 2002 that has been placed atop the collection light guide 2006 for scanning purposes. The collection light guide 2006 may be divided into several segments, portions, or zones; in this example, the collection light guide has been divided into four quadrants. While each quadrant is shown as separated from neighboring quadrants by a small gap, in practice, the quadrants may be in contact with one another or bonded together. Alternatively, the quadrants may simply refer to different areas of a contiguous part. Within each quadrant, light-turning structures 2010 may be located. The light-turning structures 2010 may be directional light-turning features 2010, and may be oriented to re-direct light that strikes the light-turning structures 2010 towards the light detector(s) 2016 bordering the quadrant of the collection light guide containing the light-turning structure 2010. Due to the directional nature of the light-turning structures 2010, the chance that light that encounters a light-turning structure 2010 within a given quadrant will be detected at a light detector 2016 associated with a different quadrant of the collection light guide 2006 may be reduced. While the collection light guide 2006 shown in FIG. 20A is divided into four segments (or quadrants) by diagonals spanning from corner to corner of the light collection guide 2006, other implementations may feature collection light guides that are partitioned into a different configuration of segments.

The segments of a collection light guide such as the collection light guide 2006 may, for example, be viewed as light-receiving zones, each of which corresponds with one or more light detectors. Light entering each light-receiving zone may, due to the presence of the directional light-turning structures 2010, be kept substantially isolated from the other light-receiving zones while being redirected towards the periphery of the light collection guide.

FIG. 20B shows an isometric exploded view of the example scanning display of FIG. 20A. The non-projection display screen 2004 is visible in more detail in this view. As can be seen, the non-projection display screen 2004 may include, for example, a 10×10 array of pixels 2040. FIG. 20B also depict a light path 2022 tracing a potential transmission path for light emitted from a bright pixel 2042. For example, light may be emitted from a bright pixel 2042 and follow a first light path 2022, travel through the collection light guide 2006, and reflect off of the object 2002 and back into the collection light guide 2006, where the light may encounter one of the light-turning structures 2010. The light-turning structure 2010 may redirect the light, for example, generally along the X axis, as depicted, and towards the light detector 2016 bordering the portion of the collection light guide 2006 where the first light path 2022 entered the collection light guide 2006. The light following the first light path 2022 may exit the collection light guide 2006 via a face that is generally normal to the X axis and be detected by the light detector 2016 adjacent to that face.

A scanning display such as scanning display 2000 in FIG. 20 may be used to implement, for example, a raster scan image capture technique. In such an implementation, a pixel or cluster of pixels may be illuminated in each of the segments simultaneously, and an intensity or luminance measurement of the light from the illumination that is reflected off an object being scanned may be obtained for each segment and associated with the XY location of the associated pixel/pixel cluster. The resulting data pairs may be used to map the measured intensity or luminance values to the XY coordinates to build up a two-dimensional map of the intensity or luminance of the light that is reflected off the object and back into the collection light guide.

A scanning display such as scanning display 2000 in FIG. 20 may also be used to implement, for example, a compressive sampling image capture technique. For example, a different compressive image pattern may be displayed using the portions of the non-projection display screen corresponding to the segments of the collection light guide. Thus, an object being scanned may be illuminated by four different compressive image patterns, and the intensity or luminance measurements of the light from these patterns that is reflected off of the object and back into the collection light guide may be measured by the light detector(s) associated with each segment. Alternatively, the same compressive image pattern may be used in each segment. The resulting pairings of compressive image pattern and measured light intensity or luminance may then, as discussed above, be used in a compressive sampling image construction process to produce an image of the scanned object. In the four-segment example, four separate compressive sampling capture images may be generated, and each may depict a different portion of the scanned object. Such partitioned capture images may then be stitched together using conventional image joining processes.

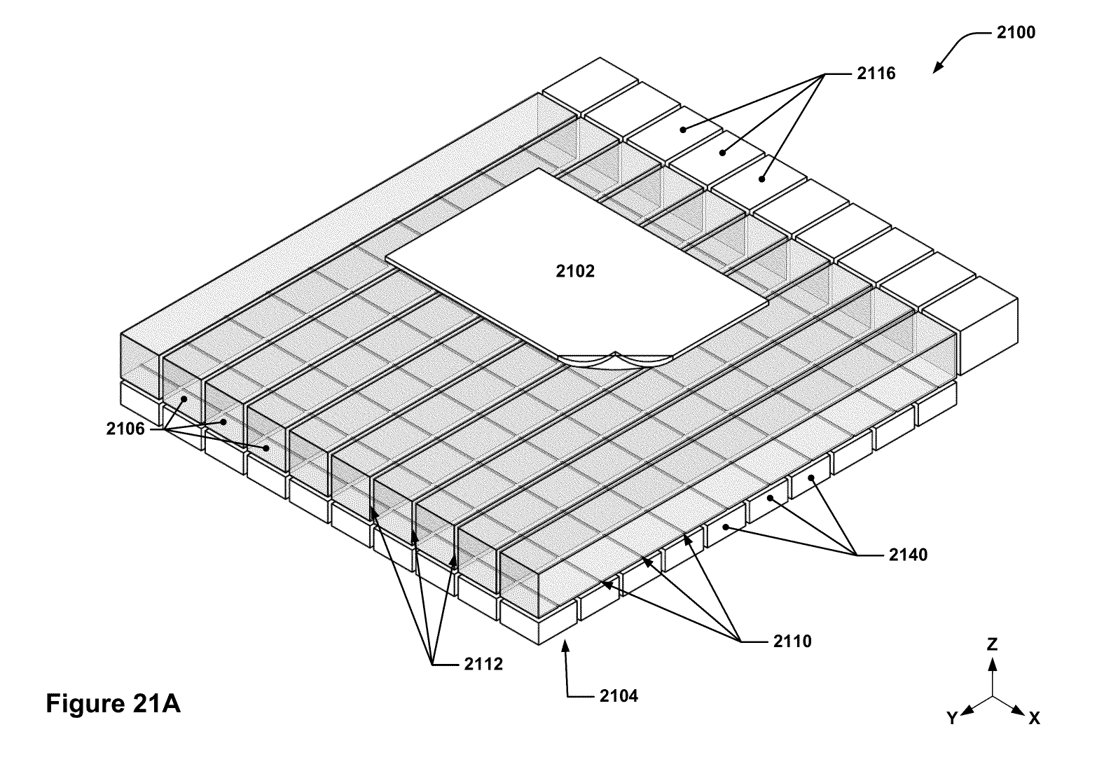

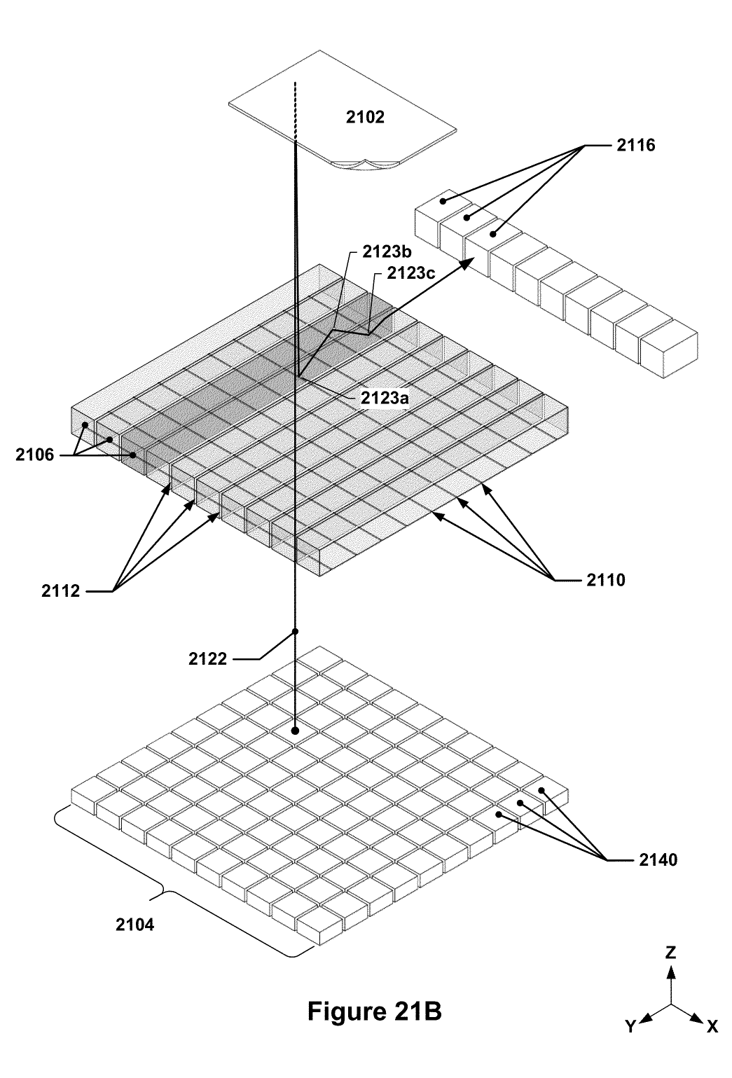

Further implementations of a scanning display may allow for line-scanning operations using a collimated collection light guide. FIG. 21A shows an isometric view of an example scanning display with a collimated, planar collection light guide.

FIG. 21B shows an isometric exploded view of the example scanning display of FIG. 21A. Scanning display 2100 in FIGS. 21A and 21B includes a non-projection display screen 2104 with a 10×10 array of pixels 2140, a collection light guide 2106 with ten generally linear collimation segments (the collimation segments, in this instance, are arrayed along a first direction corresponding with the X axis) and an array of light detectors 2116. Each segment of the collection light guide 2106 may be viewed as a light-receiving zone; each light detector 2116 may be configured to detect light that enters the light-receiving zone with which it is associated and that is then redirected so as to be emitted from the end of the collection light guide 2106 segment. The collection light guide 2106 may include a number of light-turning structures 2110. The interface between each segment may include structures 2112, such as a low index gap such as air or other low index material, that serve to prevent light reflecting within one segment from bleeding into the adjacent segments.

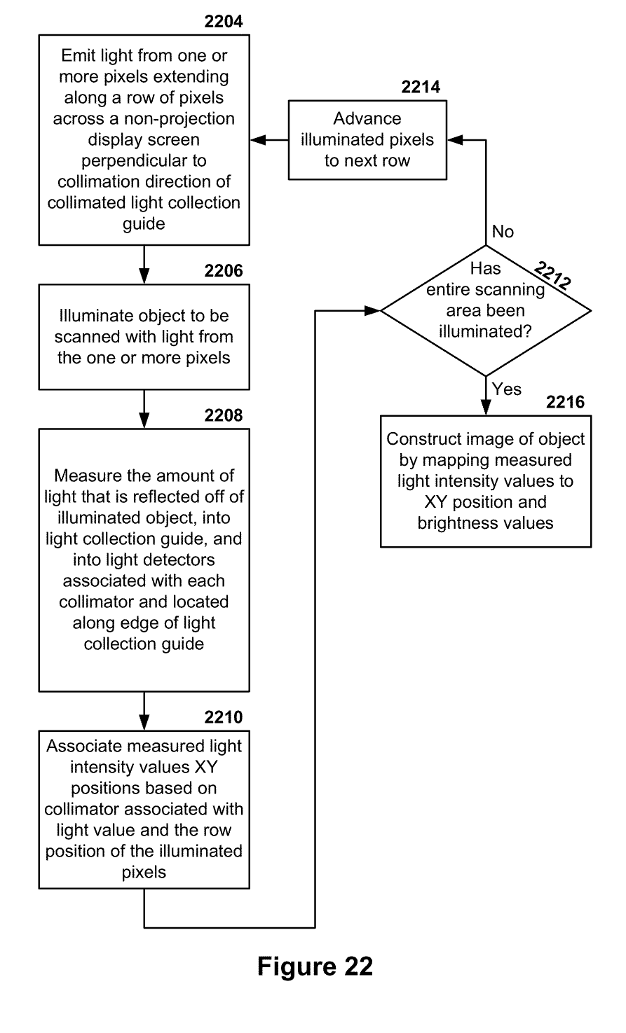

The scanning display 2100 of FIGS. 21A and 21B may be used to perform “line scans” of an object 2102 placed on or near the scanning display 2100. FIG. 22 shows a block diagram of an example technique for using a scanning display as described herein to perform raster line scanning image acquisition. For example, in the implementation pictured, such a technique may begin in block 2204 and may involve emitting light from a line or multi-pixel band, for example, array, of pixels across the non-projection display screen 2104, for example, in a direction parallel to the X axis (block 2204). Such a line or multi-pixel band, such as an array, of pixels across the non-projection display screen 2104 that is oriented in a direction parallel to the X axis may also be a line of pixels that is perpendicular to the collection light guide segments 2106. Light from the illuminated pixels may pass through the collection light guide 2106. Light that passes through the collection light guide 2106 and strikes the object 2102 (block 2206) may be reflected back into the indicated collimation segment of the collection light guide 2106 and may then strike one of the light-turning structures 2110 at location 2123a. This is illustrated by the first light path 2122 shown in FIG. 21B. After striking one of the light-turning structures 2110, the light may be redirected to follow the first light path 2122 towards the end of the segment of the collection light guide 2106 that is adjacent to the light detector 2116 that is associated with that segment (the collimation segment of the collection light guide 2106 through which the light passes is shaded a darker shade of grey in FIG. 21B for ease of reference). The light may be conducted down the length of the segment by a total internal reflection mechanism, for example, the light may reflect off of the internal surfaces of the indicated collimation segment of the collection light guide 2106 at locations 2123b and 2123c. The intensity or luminance of the light that travels down each of the segments and reaches the periphery of the collection light guide 2106 may be measured by the light detector(s) 2116 that correspond to the segment (block 2208). The measured light intensity or luminance values for each segment may then be associated with the Y axis location of the line or band of pixels and the X axis location of the segment or the associated light detector 2116. For example, when pixels at a particular row location are illuminated, the measured light intensity values resulting from such illumination may be stored in a memory in association with information identifying the row location and the light detector 2116 that measured the intensity. This allows measured light intensities to be mapped to XY locations across the scanning display 2100. In block 2212, a determination may be made as to whether the entire desired scanning area has been illuminated. If not, the line or band of pixels may be advanced (or otherwise moved to a new location) in the Y direction to potentially illuminate a new portion of the object 2102. This process may repeat until the entire desired scanning area has been illuminated. Once all of the desired scanning area has been illuminated and measured light intensities or luminance associated with corresponding XY coordinates, the resulting intensity/luminance XY data may be used to construct an image of the scanned object 2102 (block 2216).

In some implementations, rather than scanning a line of illuminated pixels across the scanning display 2100 row-by-row (for example, in rows that are perpendicular to light guide segments 2106), each collimated segment of the collection light guide 2106 may be used in a manner similar to the segments discussed with respect to FIGS. 20A and 20B. For example, the pixels underneath each collimation segment of the light collection guide 2106 may be used to display a series of compressive image patterns, each compressive image pattern substantially the same size as the collimation segment overlaying it. Compressive sampling techniques may then be used to construct a set of images, each correlated with one of the collimation segments, that may then be stitched together to form a single image of the scanned area of the scanning display 2100. By performing several smaller-scale compressive sampling image constructions in parallel rather than a single larger one, the number of compressive image patterns that may be required may be drastically reduced. This may reduce the amount of time required to acquire the constructed image.

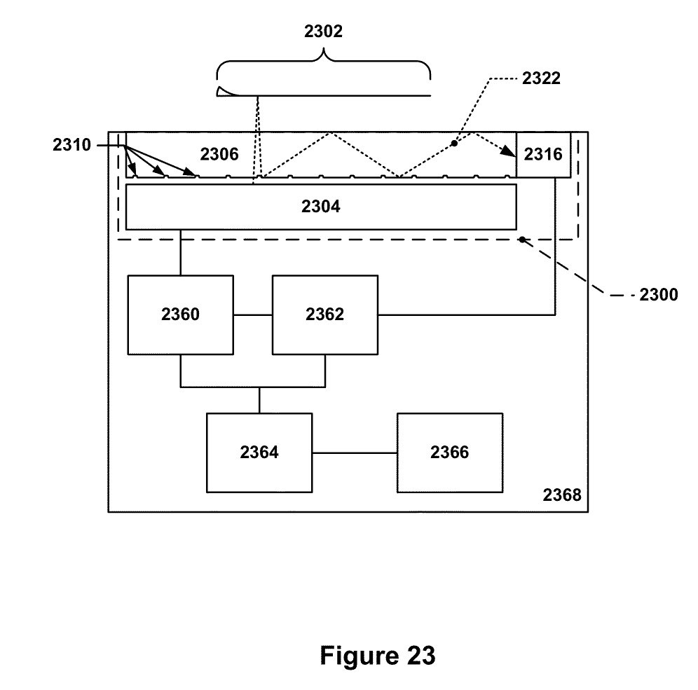

The scanning displays discussed above may be controlled using a display controller, light detector controller, processor, and/or similar hardware. FIG. 23 shows a block diagram of an example scanning display and control system for the scanning display.

In FIG. 23, a device 2368, for example, a cell phone, tablet computing device, or other electronic device featuring a display screen, includes a scanning display 2300 that includes a non-projection display screen 2304, a collection light guide 2306, and a light detector 2316, which generally correspond in function and purpose to similar structures shown in FIG. 10. Of course, other scanning displays may be used, including scanning displays such as the other implementations discussed above. An object 2302 to be scanned may be placed above or on the collection light guide 2306.

Also included in device 2368 are a display controller 2360, a light detector controller 2362, a processor 2364, and a memory 2366, which may be operatively connected with one another. The display controller 2360 may be configured to receive data describing graphical output for the non-projection display screen 2304, and may be configured to transform the data into a signal that instructs the non-projection display screen 2304 to produce a desired pattern of bright and dark pixels, in other words, display the graphical content. The display controller 2360 may be used to control the non-projection display screen 2304 to, for example, display the single pixels/pixel clusters, compressive image patterns, or scan lines or bands discussed above.

The light detector controller 2362 may be configured to receive detected light intensity or luminance data from the light detector(s) used in the scanning display 2300. The light detector controller 2362 also may be configured to receive data from the processor 2364 or the display controller 2360 regarding the content that is displayed by the non-projection display screen 2304 at the time that the light intensity or luminance data is measured and to associate the content data with the measurement data.

The processor 2364 may be configured to receive the light intensity or luminance data from the light detector controller and, using data describing the graphical content associated with each piece of light intensity or luminance data, construct an image of the scanned object 2302 using such data. The processor 2364 may, for example, be programmed to perform any of the techniques outlined in, for example, FIGS. 17, 18, and 22. Computer-executable instructions for implementing such techniques may be stored on the memory 2366. The memory 2366 also may be used to store any constructed images produced by the processor 2364.

It is to be understood that the functionality of the display controller 2360, the light detector controller 2362, and the processor 2364 may, of course, be combined into a lesser number of components or into a single component, or apportioned between a greater number of components, without deviating from the scope of this disclosure.

In the examples provided herein, the illumination used to illuminate the scanned object has generally been described in “bright” and “dark” terms. In some implementations, the scanning display may be configured to obtain greyscale images and, the bright pixels may emit, for example, white light, and the dark pixels no light. In some other implementations, however, color images may be constructed by repeating the detected light measurements multiple times using different wavelengths of light. For example, if compressive sampling is used, each compressive image pattern could be displayed three times: once with green bright pixels, once with blue bright pixels, and once with red bright pixels. The resulting green, blue, and red light intensity or luminance measurements may be paired with the corresponding compressive image patterns that resulted in the measurements and used to construct three mono-chromatic images of a scanned object that may then be combined to provide a single, broad-spectrum color image. An alternative to this process may be to use white light (or other broad, fixed-spectrum light) from, for example, a monochrome non-projection display screen to illuminate a scanned object. The light that is reflected off of the object and back into the collection light guide may then be directed towards a plurality of light detectors, each selectively sensitive to one of several colors that make up the white light spectrum, for example, red-, green-, and blue-sensitive detectors may be used. The resulting spectrum-specific illumination datasets may then be used to produce mono-chromatic images of the scanned object that may be combined to produce a broad-spectrum image of the scanned object. Alternatively, the light may be passed through an active, tunable filter interposed between the collection light guide and the light detector(s). The tunable filter wavelength transmissivity may then be altered to allow only light of certain wavelengths to reach the light detectors. For example, for any given display of a compressive image pattern, the tunable filter could be cycled through successive modes where only green light, only red light, and only blue light are allowed to reach the light detector(s). The resulting compressive image pattern/light intensity or luminance measurement pairings may then be used as described above to produce constructed images in each of several wavelengths. The constructed images may then be combined to provide a broad-spectrum image. In this manner, a scanning display with a monochromatic non-projection display screen may be used to produce broad-spectrum scanned images of an object placed on or above the scanning display.

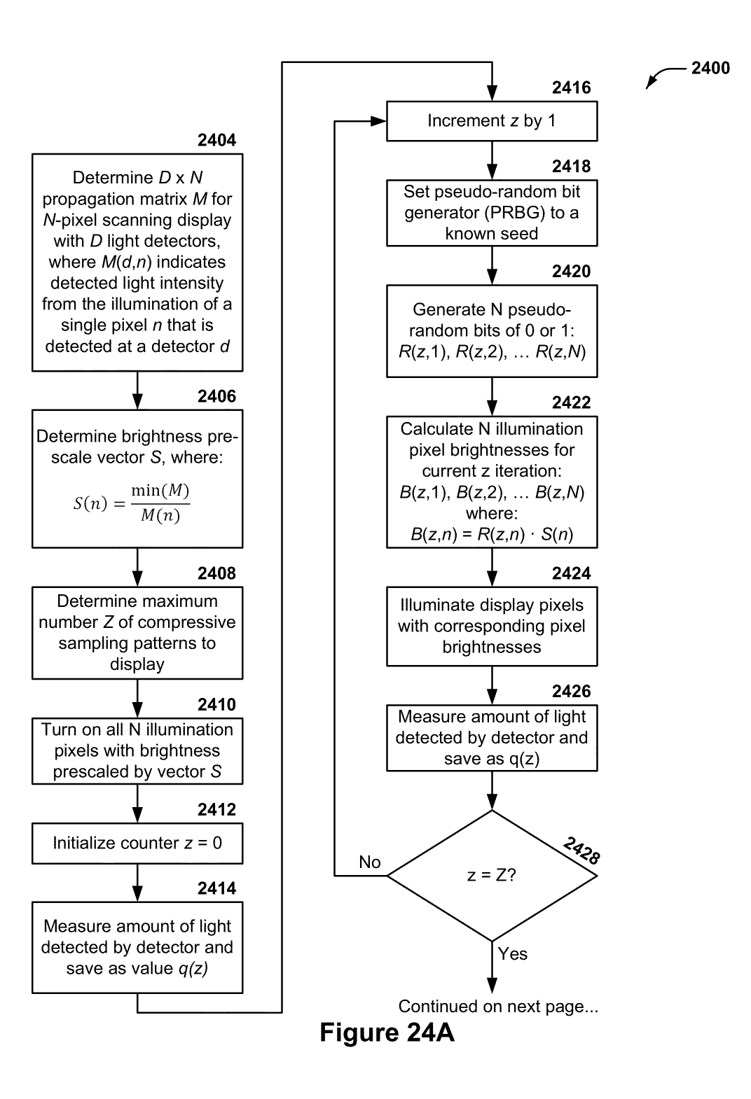

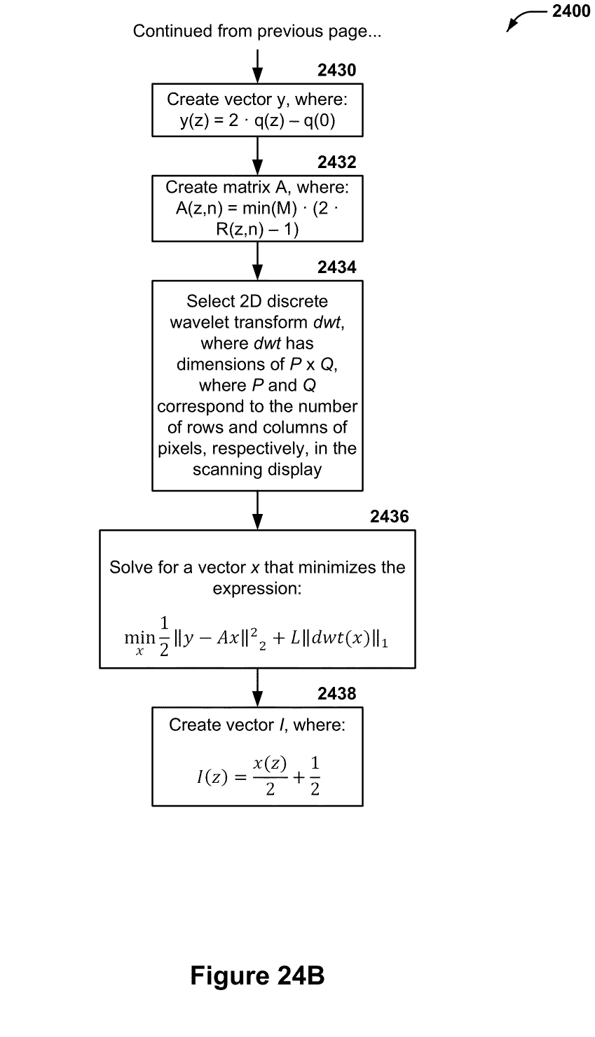

FIGS. 24A and 24B depict a flow diagram for a compressive sampling image construction technique using illumination pre-scaling. Because of the relative scarcity of light detectors in a scanning display system as compared to the number of illumination pixels supported by the scanning display system, each detector in the scanning display may receive different fractions of light from each illumination pixel, even when the pixels illuminate an object with uniform reflectivity. This is because of the relative positioning of the pixels (and light turning features) with respect to the light detectors. By using a pre-scaling technique, variations in the light fraction from each pixel that are received at each light detector may be minimized.

In block 2404, a D×N propagation matrix may be determined for a given patterned illumination scanning display with N pixels and D light detectors. Each element M(d,n) of the propagation matrix may represent the fraction of light emitted by a single pixel n of the scanning display that is reflected off of a calibration object with uniform reflectivity, for example, a matte white surface, across the entire scanning area of the scanning display and redirected by a collection light guide into a light detector d for measurement.

In block 2406, a brightness pre-scale matrix S may be defined by dividing the minimum element of the matrix M by each element of the matrix M. In this example, the number of detectors in the scanning display is 1, so the M matrix and the resulting S matrix simplify to one-dimensional matrices, in other words, vectors. This example will refer to these matrices as “vectors” for the purpose of this discussion. It is to be understood, however, that the principles outlined herein may also be used with multi-detector systems with suitable modifications to the underlying technique. For example, in a multi-detector system, the pre-scaling factors may be chosen to minimize the range of detected light values at each detector resulting from illumination of the calibration object by the set of all pixels. Any remaining variation in the light contribution of each pixel may be compensated for use post-scaling techniques (discussed later below).

In block 2408, a maximum number of compressive sampling patterns to display is established. Generally speaking, this may be set to a default such as approximately one tenth of the total number of pixels in the scanning display, or may be user- or machine-selectable or adjustable depending on the desired image quality. For example, when a lower quality image is desired, fewer compressive imaging samples may be used. Conversely, when a higher quality image is desired, an increased number of compressive imaging samples may be used.

The number of compressive imaging samples required may be approximately four times the number of pixels, N, times a compressibility factor. The compressibility factor indicates the approximate sparseness of the image in the linear-algebra basis used in the construction. The compressibility factor may be selected to correlate with the human perception of the image quality. For example, if an N pixel image can be compressed using the JPEG-2000 compression algorithm to a factor of 40:1, and maintain a suitable image quality, then using the same linear-algebra basis as JPEG-2000 in the compressive sampling construction and choosing N/10 as the number of compressive imaging samples would provide similar image quality.

In block 2410, all pixels in the scanning display are turned on simultaneously with individual brightnesses defined by the brightness pre-scale vector S. The light from the pixels reflected off of a subject object placed in front of, or on top of, the scanning display and then redirected towards the light detector by the collection light guide may then be measured by the light detector.

In block 2412, a counter z is initialized at zero, and in block 2414, the amount of light emitted from the scanning display that is then measured by the light detector is saved as q(z). After this initial measurement, the counter z is incremented by 1 in block 2416. In block 2418, a pseudo-random bit generator (PRBG) may be set to a known seed and used to generate N pseudorandom bits of 0 or 1, which may be represented in a matrix R(z,N), in block 2420. For each iteration of z, a different vector of pseudorandom bits may be generated. The values of these bits determine whether or not each corresponding pixel n is “light” or “dark.”

In block 2422, pixel brightnesses B(z,n) for each individual pixel in the scanning display are calculated by multiplying the bit value R(z,n) associated with each pixel by the brightness pre-scale value S(n) associated with that pixel. Each display pixel in the scanning display associated with a non-zero R(z,n) value may then be illuminated simultaneously in block 2424 according to the associated pixel brightness B(z,n) values. For pixels with associated R(z,n) values of 0, the resulting brightness B(z,n) will be 0. For each pixel with an associated R(z,n) value of 1, the resulting brightness B(z,n) will be a value greater than 0 and less than or equal to the maximum brightness supported by the display pixels. The resulting image, which may be a random pattern of black, full-brightness, and various intermediate-brightness pixels, may be referred to as a compressive sampling pattern.

The amount of light emitted from the display pixels that is reflected off of the subject object and that is then redirected by the light collection guide into the light detector may be measured in block 2426 and saved as q(z). In block 2428, a determination may be made whether z is equal to the maximum number of compressive sampling patterns Z determined in block 2408. If z is not equal to Z, then the technique may return to block 2416, and further compressive sampling patterns may be used. If z equals Z, then the technique may proceed to block 2430, where a vector y(Z) may be defined, each element y(z) defined by multiplying q(z) by 2 and subtracting q(0) from this product. It is to be understood that vector y(Z) is defined for z=1 to Z, in other words, there is no z=0 element for vector y(Z).

In block 2432, a z by N matrix A may be created where each element A(z,n) is defined by the minimum element value of matrix M multiplied by the quantity of two times R(z,n) minus 1. It is to be understood that matrix A is defined for z=1 to Z, in other words, there is no z=0 element for matrix A. In block 2434, a two-dimensional discrete wavelet transform dwt may be selected, for example, one of the set of Cohen-Daubechies-Feauveau wavelet transforms used with the JPEG-2000 algorithm, where dwt has the dimensions P by Q, where P and Q correspond to the number of rows and columns of pixels, respectively, in the scanning display, in other words, N=P×Q. In other implementations, a different class of transforms may be used, for example, the discrete cosine transform, depending on the choice of a linear-algebra basis to optimize for better compression, processing requirements, etc.

In block 2436, a standard quadratic programming technique, for example, an interior point method algorithm, may be used to solve for a vector x that minimizes the expression:

$${min}_{x} \frac{1}{2} {‖ y - Ax ‖}_{2}^{2} + L {‖ d wt ( x ) ‖}_{1}$$

The resulting vector x may then be used in block 2438 to produce a vector I, where I(z) is determined by adding one half to the quantity x(z) divided by two. The vector I represents the N-pixel image of the subject object. There is no direct mapping from the detector values, q, to the image of the subject, I, since q has dimension Z and I has dimension N, and Z<<N. However, the quadratic programming algorithm will choose I that has a best-fit to the detector values q. Because real-life images are compressible, the sparsity assumption of compressive sampling (given by minimizing the L1 norm of dwt(x) in the quadratic programming problem) provides nearly exact recovery of the compressible image with fewer than N samples.

The above example technique 2400 presumes that all of the pixels in the scanning display are used during the scanning process. However, similar techniques may be used for scanning display image capture when fewer than all of the pixels in the scanning display are used. In such implementations, blocks where actions involve all of the pixels in the scanning display may be modified to only use the pixels that are actively involved in the scanning process.

In some implementations, multiple scanning display image acquisition techniques may be performed in parallel using different light detectors and directional collection light guides. For example, a directional light collection guide with four sides may be configured to direct light to each of the four sides depending on which quadrant of the light collection guide received the light. The scanning display pixels and light detector associated with each quadrant may be treated as separate scanning display sub-systems for the purposes of the example technique 2400. When such an implementation is used to capture an image of a scanned object, the coherent images output by the four scanning display sub-systems may be stitched together to form a single, larger image of the entire scanning field.

It is also to be understood that certain steps of the example technique 2400 may be performed once or may be recycled from one implementation of the technique to the next. For example, blocks 2404 and 2406 may occur during production of an electronic device with scanning display functionality as part of a calibration process. It may not be necessary for blocks 2404 and 2406 to be performed again, unless recalibration of the scanning display is desired. For example, if dust or dirt contaminates the scanning display or a protective cover glass over the scanning display, recalibration may be desired.

Similarly, data from blocks 2418 through 2422 and blocks 2432 and 2434 may be recycled from one implementation of the example technique 2400 to the next. This may save considerable computational overhead, as it is not necessary to always calculate, for example, a Z by N matrix of pseudorandom bits—the same Z by N matrix of pseudorandom bits may be used from implementation to implementation of the technique 2400.

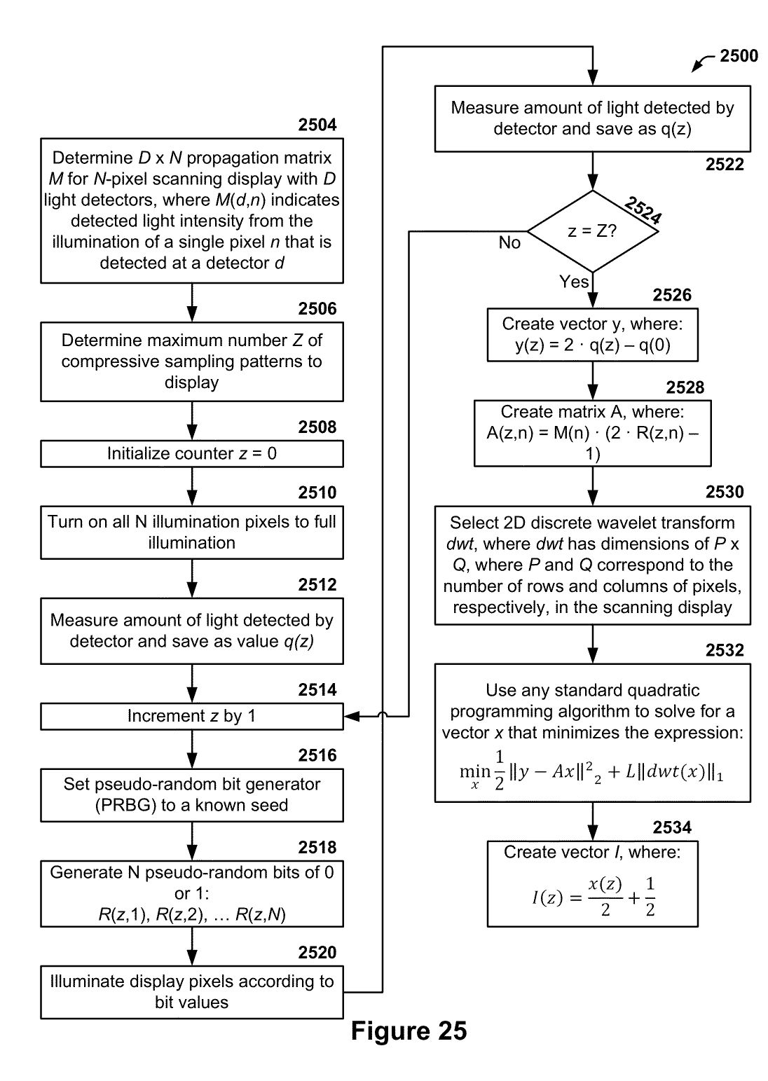

FIG. 25 depicts a flow diagram for a compressive sampling image construction technique using illumination post-scaling. Such a technique may take the place of a pre-scaling technique, as discussed above, or may be used to augment such a pre-scaling technique. For illustration a scanning display with only one light detector is used in this example, although similar techniques may be practiced with multiple light detectors.

In block 2504, a D×N propagation matrix may be determined for a given patterned illumination scanning display with N pixels and D light detectors. Each element M(d,n) of the propagation matrix may represent the fraction of light emitted by a single pixel n of the scanning display that is reflected off of a calibration object with uniform reflectivity, for example, a matte white surface, across the entire scanning area of the scanning display and redirected by a collection light guide into a light detector d for measurement.

In block 2506, a maximum number of compressive sampling patterns to display is determined. This maximum number Z may be determined in the same manner that the maximum number of compressive sampling patterns from block 2408 is determined. In block 2508, a counter z may be initialized at zero.

In block 2510, all of the pixels that will potentially be used to illuminate an object to be scanned by the scanning display may be turned on to full illumination. The light from the pixels reflected off of a subject object placed in front of, or on top of, the scanning display and then redirected towards the light detector by the collection light guide may then be measured by the light detector and saved as value q(z) in block 2512. After this initial measurement, the counter z is incremented by 1 in block 2514. In block 2516, a PRBG may be set to a known seed and used to generate N pseudorandom bits of 0 or 1, which may be represented in a matrix R(z,N), in block 2518. For each iteration of z, a different vector of pseudorandom bits may be generated. The values of these bits determine whether or not each corresponding pixel n is “light” or “dark.”

In block 2520, each display pixel in the scanning display associated with a non-zero R(z,n) value may be illuminated simultaneously. Pixels with associated R(z,n) values of 0 may be unilluminated. For each pixel with an associated R(z,n) value of 1. The resulting image, which may be a random pattern of black and bright pixels, may be referred to as a compressive sampling pattern.

The amount of light emitted from the display pixels that is reflected off of the subject object and that is then redirected by the light collection guide into the light detector may be measured in block 2522 and saved as q(z). In block 2524, a determination may be made whether z is equal to the maximum number of compressive sampling patterns Z determined in block 2526. If z is not equal to Z, then the technique may return to block 2514, and further compressive sampling patterns may be used. If z equals Z, then the technique may proceed to block 2526, where a vector y(Z) may be defined, each element y(z) defined by multiplying q(z) by 2 and subtracting q(0) from this product. It is to be understood that vector y(Z) is defined for z=1 to Z, in other words, there is no z=0 element for vector y(Z).

In block 2528, a Z by N matrix A may be created where each element A(z,n) is defined by the corresponding element value of matrix M(n) multiplied by the quantity of two times R(z,n) minus 1. It is to be understood that matrix A is defined for z=1 to Z, in other words, there is no z=0 element for matrix A. In block 2530, a two-dimensional discrete wavelet transform dwt may be selected, for example, one of the set of Cohen-Daubechies-Feauveau wavelet transforms used with the JPEG-2000 algorithm, where dwt has the dimensions P by Q, where P and Q correspond to the number of rows and columns of pixels, respectively, in the scanning display, in other words, N=P×Q. In other implementations, a different class of transforms may be used, for example, the discrete cosine transform, depending on the choice of a linear-algebra basis to optimize for better compression, processing requirements, etc.

In block 2532, a standard quadratic programming technique, for example, an interior point method algorithm, may be used to solve for a vector x that minimizes the expression:

$${min}_{x} \frac{1}{2} {‖ y - Ax ‖}_{2}^{2} + L {‖ d wt ( x ) ‖}_{1}$$

The resulting vector x may then be used in block 2534 to produce a vector I, where I(z) is determined by adding one half to the quantity x(z) divided by two. The vector I represents the N-pixel image of the subject object. There is no direct mapping from the detector values, q, to the image of the subject, I, since q has dimension Z and I has dimension N, and Z<<N. However, the quadratic programming algorithm will choose I that has a best-fit to the detector values q. Because real-life images are compressible, the sparsity assumption of compressive sampling (given by minimizing the L1 norm of dwt(x) in the quadratic programming problem) provides good recovery of the compressible image with fewer than N samples.

The above example technique 2500 presumes that all of the pixels in the scanning display are used during the scanning process. However, similar techniques may be used for scanning display image capture when fewer than all of the pixels in the scanning display are used. In such implementations, blocks where actions involve all of the pixels in the scanning display may be modified to only use the pixels that are actively involved in the scanning process.

In some implementations, multiple scanning display image acquisition techniques may be performed in parallel using different light detectors and directional collection light guides. For example, a directional light collection guide with four sides may be configured to direct light to each of the four sides depending on which quadrant of the light collection guide received the light. The scanning display pixels and light detector associated with each quadrant may be treated as separate scanning display sub-systems for the purposes of the example technique 2500. When such an implementation is used to capture an image of a scanned object, the coherent images output by the four scanning display sub-systems may be stitched together to form a single, larger image of the entire scanning field.

It is also to be understood that certain steps of the example technique 2500 may be performed once or may be recycled from one implementation of the technique to the next. For example, blocks 2504 and 2506 may occur during production of an electronic device with scanning display functionality as part of a calibration process. It may not be necessary for blocks 2504 and 2506 to be performed again, unless recalibration of the scanning display is desired. For example, if dust or dirt contaminates the scanning display or a protective cover glass over the scanning display, recalibration may be desired.

Similarly, data from blocks 2516 and 2518 and blocks 2528 and 2530 may be recycled from one implementation of the example technique 2500 to the next. This may save considerable computational overhead, as it is not necessary to always calculate, for example, a Z by N matrix of pseudorandom bits—the same Z by N matrix of pseudorandom bits may be used from implementation to implementation of the technique 2500.

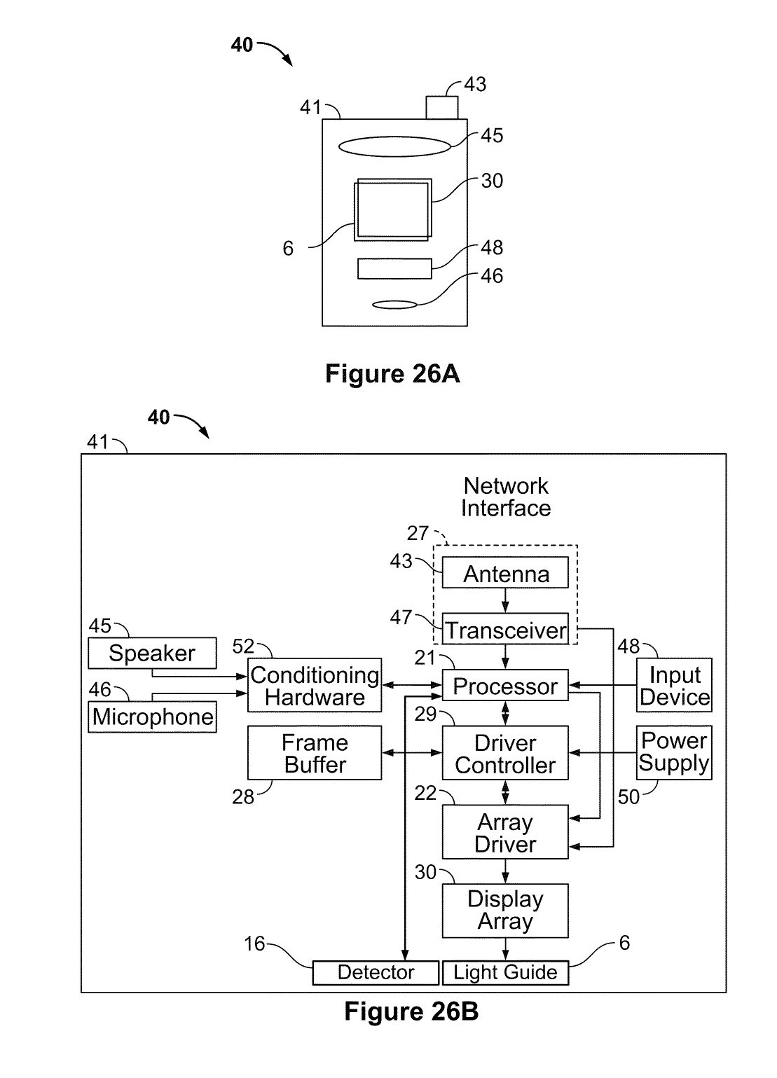

FIGS. 26A and 26B show examples of system block diagrams illustrating a display device 40 that includes a plurality of interferometric modulators. The display device 40 can be, for example, a cellular or mobile telephone. However, the same components of the display device 40 or slight variations thereof are also illustrative of various types of display devices such as televisions, e-readers and portable media players.

The display device 40 includes a housing 41, a display 30, an antenna 43, a speaker 45, an input device 48, and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber, and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

A collection light guide 6 may be included as well and be overlaid on the display 30. The collection light guide 6 may be, for example, one of the collection light guides discussed earlier, and may allow, for example, the cellular or mobile phone to scan objects placed on or near the display 30.

The components of the display device 40 are schematically illustrated in FIG. 26B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (for example, filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 can provide power to all components as required by the particular display device 40 design.

Also shown in FIG. 26B are a collection light guide 6 and a light detector 16, such as those described earlier. The collection light guide 6 may be used to collect light emitted from the display array 30 that is reflected off of an object and back into the collection light guide 6. The light may be conducted by the collection light guide 6 to the light detector 16, which may then communicate data indicating the measured intensity or luminance of the light that reaches the light detector 16 to, for example, processor 21.

The components illustrated in FIG. 26B may, for example, perform some or all of the functionality provided by the components shown in FIG. 23. For example, the processor 21 of FIG. 26B may perform functions performed by the processor 2364 and light detector controller 2362 of FIG. 23. Alternatively, additional components, such as those depicted in FIG. 23, may be added to the system depicted in FIG. 26B to provide scanning capability.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g or n. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation, and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (for example, an IMOD controller). Additionally, the array driver 22 can be a conventional driver or a bi-stable display driver (for example, an IMOD display driver). Moreover, the display array 30 can be a conventional display array or a bi-stable display array (for example, a display including an array of IMODs). In some implementations, the driver controller 29 can be integrated with the array driver 22. Such an implementation is common in highly integrated systems such as cellular phones, watches and other small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices as are well known in the art. For example, the power supply 50 can be a rechargeable battery, such as a nickel-cadmium battery or a lithium-ion battery. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, in other words, one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus comprising:
a non-projection display screen;
a collection light guide overlaid on the non-projection display screen, the collection light guide having a first surface facing the non-projection display screen and a second surface facing away from the non-projection display screen, the second surface being substantially parallel to, and coextensive with, the first surface; and
one or more light detectors positioned about the periphery of the collection light guide, wherein the collection light guide is configured to redirect light entering the collection light guide via the second surface towards the periphery of the collection light guide.

2. The apparatus of claim 1, wherein the collection light guide is a planar light guide containing light-turning structures, the light-turning structures configured to redirect the light entering the collection light guide via the second surface towards the periphery of the collection light guide.

3. The apparatus of claim 2, wherein each of the one or more light detectors positioned about the periphery of the collection light guide is positioned so as to detect light emitted from a face of the collection light guide, the face having an edge generally defining a portion of the second surface.

4. The apparatus of claim 1, wherein the collection light guide is substantially coextensive with the non-projection display screen.

5. The apparatus of claim 1, wherein:
the periphery of the collection light guide includes four sides substantially forming a rectangle,
each of the sides has at least one of the one or more light detectors positioned so as to detect light emitted from the collection light guide via the side,
the collection light guide includes four quadrants, and
light entering the collection light guide via the second surface is substantially redirected towards a side correlated to the quadrant of the collection light guide where the light entered the collection light guide.

6. The apparatus of claim 1, wherein:
each of the one or more light detectors has a primary axis of light detection, and
each of the one or more light detectors is oriented such that the primary axis of light detection is substantially normal to the first surface.

7. The apparatus of claim 1, wherein:
each of the one or more light detectors has a primary axis of light detection, and
each of the one or more light detectors is oriented such that the primary axis of light detection is substantially parallel to the first surface.

8. The apparatus of claim 1, further comprising:
a front light guide with a third surface and a fourth surface substantially parallel to and coextensive with the third surface; and
one or more light sources positioned along the periphery of the front light guide, wherein:
the front light guide is interposed between the collection light guide and the non-projection display screen,
the third surface faces the non-projection display screen,
the fourth surface faces the collection light guide, and
the front light guide is configured to redirect light from the one or more light sources entering the front light guide via the periphery of the front light guide towards the non-projection display screen.

9. The apparatus of claim 1, wherein the non-projection display screen is a reflective display screen.

10. The apparatus of claim 1, wherein the non-projection display screen is a transmissive, backlit display screen.

11. The apparatus of claim 1, wherein the collection light guide is configured to permit substantially more light to pass through from the first surface to the second surface than from the second surface to the first surface.

12. The apparatus of claim 1, further comprising:
a control system, the control system including:
at least one processor, the at least one processor being configured to process image data, and
at least one memory device, the at least one memory device communicatively connected with the at least one processor and storing instructions executable by the at least one processor, the instructions including instructions to control the at least one processor to:
cause the non-projection display screen to display a plurality of image patterns, each image pattern including bright pixels and dark pixels;
collect light intensity data from the one or more light detectors while each image pattern is displayed;
correlate the collected light intensity data with each image pattern; and
construct an image of an object, wherein the object is positioned proximate to the second surface while the image patterns are displayed.

13. The apparatus of claim 12, further comprising a driver circuit configured to send at least one signal to the display screen.

14. The apparatus as recited in claim 13, further comprising a controller configured to send at least a portion of the image data to the driver circuit.

15. The apparatus as recited in claim 12, further comprising an image source module configured to send the image data to the at least one processor.

16. The apparatus as recited in claim 15, wherein the image source module includes at least one of a receiver, transceiver, and transmitter.

17. The apparatus as recited in claim 12, further comprising an input device configured to receive input data and to communicate the input data to the processor.

18. The apparatus as recited in claim 12, wherein:
each image pattern is a pseudorandom image pattern of bright pixels and dark pixels, and
the image of the object is constructed using compressing sampling techniques.

19. The apparatus of claim 12, wherein:
the second surface is subdivided into a plurality of parallel light-receiving zones in a first direction,
each light-receiving zone corresponds to at least one of the one or more light detectors, wherein light passing into the collection light guide from each light-receiving zone is redirected and channeled along a mean path substantially perpendicular to the first direction and parallel to the second surface,
the light from each light-receiving zone is kept substantially isolated from the light from the other light-receiving zones during redirection and channeling, and
the at least one light detector corresponding to each light-receiving zone is positioned so as to detect the light channeled from each light-detecting zone.

20. The apparatus of claim 19, wherein each image pattern comprises dark pixels and an array of bright pixels extending across the non-projection display screen in a direction parallel to the first direction.

21. The apparatus of claim 12, wherein each image pattern is monochromatic and the instructions further comprise instructions to control the at least one processor to correlate the collected light intensity data for each image pattern with the color of the image pattern.

22. A machine-readable, non-transitory storage medium, the machine-readable, non-transitory storage medium having computer-executable instructions stored thereon for controlling one or more processors to:
cause a non-projection display screen to display a plurality of image patterns, each image pattern including bright pixels and dark pixels;
collect light intensity data from one or more light detectors while each image pattern is displayed, wherein:
the one or more light detectors are positioned about the periphery of a collection light guide overlaid on the non-projection display screen, and
the collection light guide is configured to take light entering the collection light guide and travelling towards the non-projection display screen and redirect the light towards the periphery of the collection light guide;
correlate the collected light intensity data with each image pattern; and
construct an image of an object, wherein the object is positioned proximate to the second surface while the image patterns are displayed.

23. The machine-readable, non-transitory storage medium of claim 22, wherein each image pattern is monochromatic and the computer-executable instructions further include instructions to control the one or more processors to correlate the collected light intensity data for each image pattern with the color of the image pattern.

24. The machine-readable, non-transitory storage medium of claim 22, wherein each image pattern is monochromatic, the machine-readable, non-transitory storage medium having further computer-executable instructions stored thereon for further controlling the one or more processors to determine the light intensity data correlated with each image pattern by summing together individual light intensity data from each of the light detectors in the one or more light detectors.

25. The machine-readable, non-transitory storage medium of claim 22, the machine-readable, non-transitory storage medium having further computer-executable instructions stored thereon for further controlling the one or more processors to display each image pattern multiple times, wherein the image patterns are monochromatic and each display of a given image pattern in the plurality of image patterns is in a different color.

26. The machine-readable, non-transitory storage medium of claim 22, the machine-readable, non-transitory storage medium having further computer-executable instructions stored thereon for further controlling the one or more processors to construct the image of the object using compressive sampling techniques, wherein each of the image patterns is a pseudorandom pattern of bright pixels and dark pixels.

27. An apparatus comprising:
a non-projection display means, the non-projection display means configured to display digital images;
means for redirecting light traveling towards the non-projection display means, the means for redirecting light overlaid on, and substantially coextensive with, the non-projection display means, wherein:
the means for redirecting light is configured to redirect the light towards the periphery of the means for redirecting light, and
the means for redirecting light is planar; and
light detection means positioned about the periphery of the means for redirecting light, the light detection means configured to detect light redirected towards the periphery of the means for redirecting light.

28. The apparatus of claim 27, further comprising:
a controller means for:
causing the non-projection display means to display a plurality of image patterns, each image pattern including bright pixels and dark pixels;
collecting light intensity data from the light detection means while each image pattern is displayed;
correlating the collected light intensity data with each image pattern; and
constructing an image of an object, wherein the object is positioned proximate to the means for redirecting light while the image patterns are displayed.

29. The apparatus of claim 28, wherein:
the controller means constructs the image of the object using compressive sampling techniques, and
each of the image patterns is a pseudorandom pattern of bright pixels and dark pixels.
